(19) United States
(12) Patent Application Publication
(10) Pub. No.: US 2024/0207780 A1
(43) Pub. Date: Jun. 27, 2024

(54) HIGH EFFICIENCY HEAT PUMP INDUSTRIAL DRYING WITH WATER VAPOR-SELECTIVE MEMBRANES

(71) Applicant: Purdue Research Foundation, West Lafayette, IN (US)

(72) Inventors: David Elan Martin Warsinger, Carmel, IN (US); James Edward Braun, West Lafayette, IN (US); Davide Ziviani, West Lafayette, IN (US); Andrew Fix, Ballwin, MO (US); Jinwoo Oh, West Lafayette, IN (US)

(21) Appl. No.: 18/542,055

(22) Filed: Dec. 15, 2023

Related U.S. Application Data
(60) Provisional application No. 63/387,858, filed on Dec. 16, 2022.

(51) Int. Cl. B01D 53/26; B01D 53/22

(52) U.S. Cl. CPC B01D 53/268; B01D 53/226; B01D 53/265; B01D 2053/224; B01D 2257/80

(57) ABSTRACT

A method of drying, including the steps of loading a mass to be dried into a drying volume, circulating air from the drying volume into a first membrane module, circulating moist air from the first membrane module to a second membrane module and circulating dried air from the first membrane module to a condenser, circulating moist air from the second membrane module to an evaporator, draining condensate from the evaporator, circulating moist air from the condenser to the evaporator, circulating heated dry air from the evaporator to the condenser, and circulating heated dry air from the condenser to the drying volume. Each respective membrane module defines an enclosure bisected by water permeable membrane for extracting water from moist air circulated therethrough. A method of passive dehumidification using hollow fiber membranes, including a quasi-counter flow effectiveness model, a partial pressure-driven ε-NTU method for mass transfer, sensitivity analysis comparing module geometries and membrane properties, optimized form factors, and scalability design guidelines. A method of active dehumidification in the form of dual-module humidity pump, including two membranes to restrict pressure ratio, a variable-speed water vapor compressor, a variable-speed vacuum pump, three-way valves for reversed air flow, and a backwash mode operation for membrane fouling prevention.

### CROSS-REFERENCE TO RELATED APPLICATIONS

This patent application claims priority to co-pending U.S. provisional patent application Ser. No. 63/387,858 filed on 16 Dec. 2022, and incorporates the entirety of same herein by reference.

### GOVERNMENT FUNDING

This invention was made with government support under DE-EE0010199 awarded by the Department of Energy. The government has certain rights in the invention.

### TECHNICAL FIELD

The present novel technology relates generally to the field of energy transfer, and, more particularly, to energy efficient dehumidification and drying processes combining low-energy heat pumps with water selective membranes.

### BACKGROUND

Convective drying processes consume a significant amount of energy within the industrial sector. Heat pump-based drying processes are gaining attention as a potential technology for enabling efficient, electric drying for various applications. Although heat pumps are receiving more attention as energy efficient options for drying, heat pumps cannot provide the elevated temperatures available from conventional combustion-based heaters and thus equitable drying times cannot be achieved by replacing combustion-based heaters with electric heat pumps.

Further, while combining the use of heat pumps with dehumidified air addresses the drying time difference, air dehumidification presents its own set of energy inefficiencies. Conventional condensation-based air dehumidification requires a significant amount of energy for the cooling, condensation, and reheating steps of the condensation cycle.

Finally, to maximize heat pump efficiency, the temperature difference between the cold heat exchanger and the hot heat exchanger should be minimized. This directive runs counter to the need to achieve the hottest possible air from the heat pump for drying purposes. Thus, there remains a need for an improved electric drying process. The present novel technology addresses this need.

### SUMMARY

A novel heat pump drying system is presented herein that employs water vapor-selective membranes for active control of the air humidity in the drying processes. System-level models for the instant system were developed as well as representative baseline systems exploiting the first and second laws of thermodynamics so as to explore energy trends and limitations of the novel concept. It was found that energy savings on the order of 30-40% are possible when high temperature, low humidity conditions are required. Furthermore, membrane dehumidification could theoretically reduce required drying temperatures by 10-20° C. while still saving energy. The unique design of the instant system and its use of exhaust air condensation may improve heat pump coefficient of performance (COP) by as much as 2x. In addition, a novel hollow fiber membrane model was introduced, integrating geometries into a partial pressure-driven ε-NTU method for quasi-counter flow configurations. Sensitivity analysis revealed module geometries had a greater impact than membrane properties on dehumidification performance. Optimal module parameters were determined as a length-to-diameter ratio of 2.9 and packing fraction of 0.49, resulting in a latent COP improvement of 460% compared to conventional systems. Scalability analysis favored parallel deployment of smaller units over a single large unit. Lastly, a new design for the system included synchronized control of vacuum pump and compressor speeds, and a strategy to prevent membrane fouling. This work shows that the instant novel system has significant potential to provide efficient, safe, and controllable conditions for industrial drying applications.

### BRIEF DESCRIPTION OF THE DRAWINGS

FIG. 1A is a schematic view of a PRIOR ART condensation dehumidification system.

FIG. 1B is a schematic view of an active membrane condensation dehumidification system according to a first embodiment of the present novel technology.

FIG. 1C is a schematic view of the system of FIG. 1B configured in passive mode.

FIG. 2A graphically illustrates dryer inlet temperature as a function of energy savings for the system of FIG. 1B.

FIG. 2B graphically illustrates dryer inlet temperature as a function of inlet dew point temperature for the system of FIG. 1B.

FIG. 3A graphically illustrates idealized dryer inlet temperature as a function of energy savings for the system of FIG. 1B.

FIG. 3B graphically illustrates idealized dryer inlet temperature as a function of inlet dew point temperature for the system of FIG. 1B.

FIG. 4A graphically illustrates idealized drying efficiency for the system of FIG. 1B.

FIG. 4B graphically illustrates practical drying efficiency for the system of FIG. 1B.

FIG. 5 graphically illustrates evaporator latent heat ratio as a function of ambient temperature for the system of FIG. 1B.

FIG. 6 graphically illustrates dryer inlet temperature as a function of inlet dew point temperature for the system of FIG. 1B.

FIGS. 7A-7E schematically illustrate one embodiment of the system of FIG. 1B.

FIGS. 8A-8E schematically illustrate one embodiment of the system of FIG. 1B.

FIGS. 9A-9D graphically illustrate the relative sensitivity to various variables for water vapor removal (9A), fan power consumption (9B), heat loss (9C), and compactness (9D).

FIG. 10A graphically illustrates ambient humidity ratio as a function of ambient temperature for the system of FIG. 1B.

FIG. 10B graphically illustrates dryer inlet humidity ratio as a function of dryer inlet temperature for the system of FIG. 1B.

FIG. 10C graphically illustrates drying effectiveness as a function of dryer inlet temperature for the system of FIG. 1B.

FIG. 10D graphically illustrates ambient mass flow ratio as a function of dryer inlet mass flow ratio for the system of FIG. 1B.

FIG. 11A graphically illustrates shell diameter as a function of mass flow rate for the system of FIG. 1B.

FIG. 11B graphically illustrates surface area as a function of mass flow rate for the system of FIG. 1B.

FIG. 11C graphically illustrates average pressure drop as a function of mass flow rate for the system of FIG. 1B.

FIG. 11D graphically illustrates COP as a function of mass flow rate for the system of FIG. 1B.

FIG. 12A is a schematic view of a dual-module humidity pump for active membrane dehumidification according to a second embodiment of the present novel technology.

FIG. 12B is a schematic view of the system of FIG. 12A configured in backwash mode.

### DETAILED DESCRIPTION

Before the present methods, implementations, and systems are disclosed and described, it is to be understood that this invention is not limited to specific synthetic methods, specific components, implementation, or to particular compositions, and as such may, of course, vary. It is also to be understood that the terminology used herein is for the purpose of describing particular implementations only and is not intended to be limiting.

As used in the specification and the claims, the singular forms “a,” “an” and “the” include plural referents unless the context clearly dictates otherwise. Ranges may be expressed in ways including from “about” one particular value, and/or to “about” another particular value. When such a range is expressed, another implementation may include from the one particular value and/or to the other particular value. Similarly, when values are expressed as approximations, for example by use of the antecedent “about,” it will be understood that the particular value forms another implementation. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not. Similarly, “typical” or “typically” means that the subsequently described event or circumstance often though may not occur, and that the description includes instances where said event or circumstance occurs and instances where it does not.

It has been estimated that thermal dehydration technologies account for anywhere between 10-20% of industrial energy consumption in developed countries. Convective drying is one of the most common types of drying technologies, employed in drying food, pharmaceuticals, fabrics, chemicals, and more. Another common application for convective drying is residential clothes dryers, which constitute 3% of residential energy consumption. Currently, industrial drying processes rely heavily on the combustion of fossil fuels. More recently, there has been increased interest in moving away from combustion-based drying technologies, in favor of energy efficient heat pump drying technologies.

Many different configurations and combinations of heat pump drying technologies have been proposed, including air-source, ground-source, solar assisted, chemical heat pumps, various forms of energy recovery, and more. However, in their simplest form, the two categories of heat pump dryers are closed and open systems. Open dryers pull in ambient air, heat it up, send it to the drying process, and then simply exhaust the warm and humid air that leaves the drying process. In a closed heat pump dryer, instead of exhausting the warm and humid air leaving the drying process, it is passed through the vapor compression cycle's evaporator to condense water out of the air, which is then reheated by the condenser of the vapor compression cycle before recirculating the heated, dry air back through the drying process.

Open heat pump systems can achieve high efficiency performance if the ambient conditions are very low humidity, but otherwise may be limited by the ambient conditions. On the other hand, closed systems are not dependent on the ambient conditions but must spend a considerable amount of energy condensing and removing water out of the air. Conventional air conditioning technologies experience similar energy penalties when dealing with humidity. Generally, closed heat pump dryers are more common in the literature, but even open systems could benefit from pre-dehumidification technologies. Thus, there is a significant need to identify an innovative technological solution to address the energy demands associated with air humidity removal in heat pump drying processes. The instant novel technology addresses this need below.

Recently, water vapor selective membranes have gained interest in air conditioning research. Conventional air conditioning technologies rely on cooling the air below its dew point to induce condensation dehumidification, and condensing water vapor requires a significant amount of energy. Instead of relying on energy-intense phase-change dehumidification, selective membranes can mechanically separate water vapor out of air, which can save energy input depending on the system design.

Most membranes used for air dehumidification are referred to as “dense” membranes, whereas many water separation or purification membranes (like desalination) are categorized as “porous” membranes. For dehumidification membranes, a dense (non-porous) hygroscopic material, usually a polymer, is coated onto a support material layer. This support material layer is typically thermally insulating, and may be made of fiberglass, a silica aerogel, a high porosity graphene foam, a thick polymer, combinations thereof, or the like. These materials can be created by such processes as electrospinning, moisture removal from a gel, high temperature treatment with a coated porous substrate, phase inverse processes, or the like. Because this hygroscopic layer is non-porous, air cannot easily penetrate, though the hygroscopic nature of the layer enables water vapor to transport across via the solution-diffusion process. Some high-performance membrane materials for dehumidification include polyether block amide resin thermoplastic elastomer combined with graphene oxide, polyvinyl alcohol combined with triethylene glycol, freestanding graphene oxide, and/or cellulose.

The two important performance metrics for the membrane materials are the permeance to water vapor and the air selectivity. The water vapor permeance simply describes the membrane's ability to pass water vapor and is analogous to a heat transfer coefficient. The units of water vapor permeance are generally some variations of kg/Pa s m². The air selectivity describes how well the membrane blocks air transport and is generally taken as the ratio of the water vapor permeance to the air permeance. Optimal membranes achieve both high selectivity and high-water vapor permeance. Top performing membranes generally achieve water vapor permeance on the order of 1,000-5,000, and selectivity up to 10,000. However, the analysis herein provides high-level thermodynamic insight into the application of membrane dehumidification in industrial drying applications in a manner that does not rely on knowing or assuming membrane material properties like permeance and selectivity.

While thermodynamic modeling for vacuum membrane dehumidification has been carried out extensively for air conditioning applications, little-to-no substantive work has been done in the field of industrial heat pump drying. The novel instant system is the first to propose a hybrid membrane dehumidification and heat pump system configuration for efficient industrial drying applications. This specification provides an introduction to the concept and explores the potential energy benefits through high-level, thermodynamic models that employ both theoretical and practical assumptions. The results provided herein serve as a basis for further detailed modeling and prototyping efforts and the establishment of a new sub-field within the heat pump and membrane research communities.

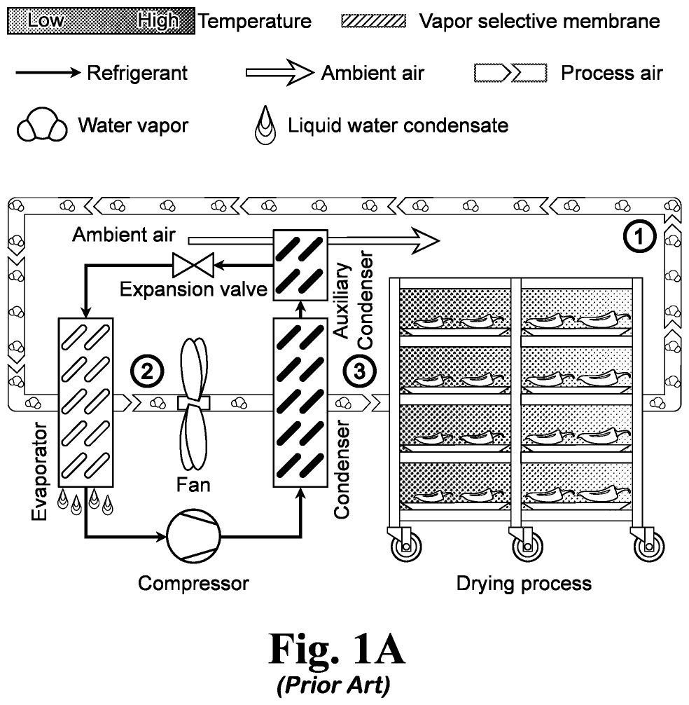

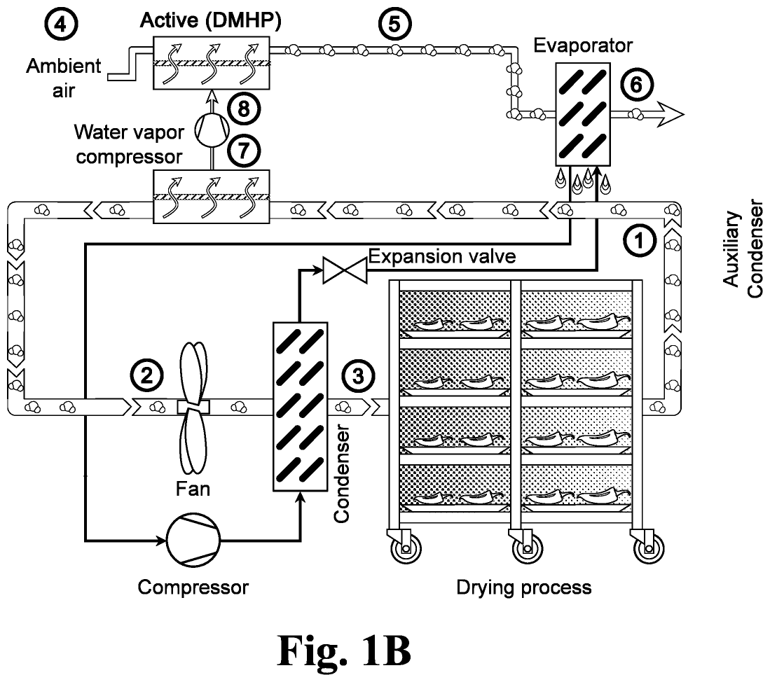

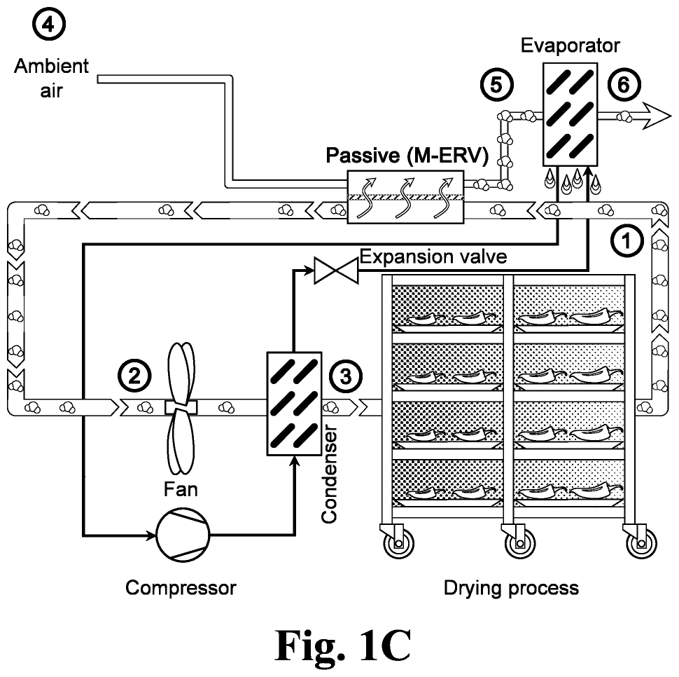

In the baseline prior art, closed heat pump dryer system (see FIG. 1) the relatively warm and humid air at State 1 is cooled to a lower temperature to induce condensation dehumidification. Because the air was cooled to induce condensation dehumidification, a significant amount of reheating must be provided by the condenser. While the condensation will provide a significant source of heat transfer in the baseline system as well, it is not strictly beneficial since it induces significant reheating requirements and lower evaporator temperatures are needed to maintain the desired humidity levels. Additionally, the condenser rate of heat transfer will be higher than the evaporator, so in order to maintain an energy balance within the drying process flow, an auxiliary condenser would be included to reject excess heat to an ambient air stream.

Herein the system that combines membrane dehumidification and heat pump drying is referred to as the “instant system”. FIG. 1B depicts the flow schematic of the instant system. Starting at State 1, relatively warm, saturated (100% relative humidity) air leaves the drying process and enters the dehumidification membrane module. A water vapor compressor maintains a low water vapor partial pressure on the top (permeate) side of the membrane. This difference in water vapor partial pressure draws humidity out of the drying process exhaust air while requiring no heat transfer. Then, the dry air at State 2 is reheated before being sent back to the drying process. Herein, both systems (baseline and instant system) are modelled such that the absolute humidity at State 2 is equivalent between both systems.

The humidity that was removed between State 1 and State 2 is then slightly pressurized by the water vapor compressor to the second membrane module. This dual-module system configuration can be viewed as analogous to a vapor compression cycle heat pump. In the vapor compression cycle, two heat exchangers are required. The evaporator pulls heat out of an air stream, the evaporated refrigerant is compressed, and then the heat is rejected to another air stream by the condenser. Similarly, the bottom membrane module in FIG. 1B pulls water vapor out of one air stream. The water vapor is slightly compressed, raising the water vapor pressure, and is then rejected to another air stream by the top membrane module, as long as the compressed vapor has a higher pressure than the water vapor partial pressure at State 4. Thus, State 5 will have a higher humidity content than State 4. The humid air at State 5 then passes through the evaporator of the vapor compression cycle, where heat is absorbed for reheating the process air (States 2 to 3). Condensing water vapor in this exhaust air is beneficial, as a significant portion of the heat transfer will come from the latent heat of vaporization. This means that, under certain conditions, warmer evaporator temperatures can be used, resulting in higher heat pump COPs.

The passive membrane dehumidification method is shown in FIG. 1C. Herein, the active dual-module configuration is not required, since the membrane energy recovery ventilator (M-ERV) allows near-free dehumidification induced by the vapor partial pressure difference between the process air and ambient air. Although this system requires increased fan power consumption to overcome the pressure drops inside the M-ERV, it has high potential in energy savings when the ambient humidity level is sufficiently low enough to meet the set point humidity level at State 3. After the water vapor is transported to the ambient sweep air, the evaporator of the vapor compression cycle absorbs both sensible and latent heat at State 5, identical to that of the instant system in FIG. 1B.

The models discussed herein are system-level, steady-state thermodynamic models based on a first-law analysis. Specific components are not modeled in detail (e.g., membrane area, heat exchanger area, membrane properties are not included in the model). This will become clear as the model is developed below. Furthermore, some portions of the model were first replicated from prior published drying technology models before extending the framework to the instant system to ensure reasonable assumptions for the model. Overall, the intent of these theoretical models is to capture performance trends for the systems with both highly idealized assumptions and more practical assumptions and to assess useful benefits and limitations.

The convective drying process is modeled the same way for both systems herein and is assumed to be a relatively ideal drying process. The supply temperature, T₃, and supply dew point temperature, T_{DP,3}, are set as inputs for most of the analyses. The supply dew point temperature is used as the metric for setting the dryer inlet humidity condition for convenience, as this will be directly tied to the evaporator temperature in the baseline system shown later. Thus, the inlet conditions, including the inlet humid air enthalpy, h₃, are known. To determine the dryer outlet conditions, we assume an ideal dryer where the drying occurs adiabatically (constant enthalpy) and the air leaving the drying process reaches 100% relative humidity. These two initial assumptions are given by Equations 1 and 2.

$${h}_{1} = {h}_{3} \qquad ( 1 )$$

$$R {H}_{1} = 1 \qquad ( 2 )$$

Thus, the inlet and outlet humid air conditions are known. Herein, a specific drying process is not explicitly modeled (conveyer drying, batch drying, etc.) Furthermore, we do not consider any dynamic behavior associated with the type of material being dried, thermal mass, or the change in drying rate as the water content changes in the product material. Similar simplifications have been made in other works and are justified herein since the focus is on providing a comparative analysis between two heat pumping technologies meeting the same theoretical drying load. Models from prior published work were obtained for comparing inlet and outlet temperature conditions for different scenarios. It was found that the maximum error between the instant model and the prior model's temperature calculations was less than 1%, giving confidence that our drying process model was consistent with other works.

Both the instant system (FIG. 1B) and baseline system (FIG. 1A) incorporate a heat pump for process air heating. Due to the high temperature lift in this application (up to 130° C. in some cases) a more complex cycle architecture could be adapted to achieve competitive COPs. However, this analysis focuses more on the comparison of the Instant system to the baseline system, emphasizing the benefits of membrane dehumidification. So, to simplify the modeling of the vapor compression cycle energy requirements, two sets of results are presented. One set of results looks at the most ideal scenario and applies Carnot COPs to evaluate energy input requirements for the heat pumps. The Carnot cooling COP and heating COP, based on the thermodynamic states in the baseline system, are given by Equations 3 and 4, respectively.

$$C O {P}_{C a r n o t , C} = \frac{{T}_{2}}{{T}_{3} - {T}_{2}} \qquad ( 3 )$$

$$C O {P}_{C a r n o t , H} = \frac{{T}_{3}}{{T}_{3} - {T}_{2}} \qquad ( 4 )$$

Similar equations can be applied to the instant system but replacing T₂ with T₆. The second set of results that are presented apply a second law efficiency (η_{II}) to estimate real vapor compression cycle COPs for high temperature lift applications. Based on a review of detailed modeling efforts for high-temperature heat pumps employing two stage compression with some form of economization, it was found that the second law efficiency was around 0.40 across a broad range of conditions. The “practical” results herein apply this second law efficiency to the Carnot COP to estimate “real” COPs, shown in Equation 5.

$$C O P = C O {P}_{C a r n o t} * {η}_{II} \qquad ( 5 )$$

Thus, the vapor compression cycle performance can be reasonably captured using the straightforward framework to compare the two systems and assess the benefits of adding membrane dehumidification.

Because the drying process is modeled identically in both systems, the remaining model derivations will focus on the portions of the two systems that remove humidity from the process air and reheat the process air.

The primary purpose of the evaporator in the baseline system is to provide dehumidification to the process air before it is reheated and sent back into the drying process. The temperature of the air at State 2 is used as an input or is varied in some of the following analyses. Since the air at State 1 is 100% relative humidity, State 2 will also be 100% relative humidity. The air-side energy balance on the evaporator in the baseline system is then given by Equation 6.

$${\dot{Q}}_{evap , b} = {\dot{m}}_{a} ( {h}_{1} - {h}_{2} - ( {ω}_{1} - {ω}_{2} ) {h}_{w} ) \qquad ( 6 )$$

Here, \dot{m}ₐ is the mass flowrate of air (on a dry basis) in the drying cycle, h represents the enthalpy of humid air, w is the air humidity ratio, and h_{w} is the enthalpy of liquid water. In a steady state vapor compression cycle, the evaporator heat transfer rate is always less than the condenser heat transfer rate. So, it is understood that if the latent load is met by the evaporator, we will have sufficient (actually excess) heat available to reheat the process air in the condenser. Thus, the power consumption for the baseline heat pump system is based on the evaporator load, given by Equation 7.

$${\dot{W}}_{b} = \frac{{\dot{Q}}_{evap , b}}{C O {P}_{c}} \qquad ( 7 )$$

Here, COP_{c} is the cooling coefficient of performance and can either be the Carnot COP (η_{II}=1) or practical COP (η_{II}=0.4), depending on the result being presented.

Based on an energy balance for a vapor compression cycle, we can calculate the heat transfer rate in the condenser (\dot{Q}_{cond,b}) according to Equation 8.

$${\dot{Q}}_{c o n d , b} = {\dot{W}}_{b} + {\dot{Q}}_{evap , b} \qquad ( 8 )$$

The actual heat transfer rate required for reheating the process air (\dot{Q}_{heat,b}) from State 2 to State 3 is given by Equation 9.

$${\dot{Q}}_{h e a t} = {\dot{m}}_{a} ( {h}_{3} - {h}_{2} ) \qquad ( 9 )$$

The enthalpy at State 2 (h₂) is known based on the set temperature and knowing the relative humidity is 100%, and the enthalpy at State 3 (h₃) is known based on the set drying temperature (T₃) and knowing that ω₃=ω₂. As discussed above, excess heat is available on the condenser side of the vapor compression cycle due to the energy balance, therefore, the heat transfer rate in the auxiliary condenser is given by Equation 10.

$${\dot{Q}}_{a u x} = {\dot{Q}}_{c o n d , b} - {\dot{Q}}_{h e a t , b} \qquad ( 10 )$$

For the instant system, the vapor compression cycle is implemented slightly differently, requiring different energy balances, and the membrane dehumidification portion of the system model must be presented.

Air leaving the drying process at State 1 enters the membrane module. In order to fairly compare both systems in this analysis, the dew point temperature at State 2 (T_{DP,2}) is equivalent in both systems for all analyses. This dew point temperature has an associated humidity ratio (ω2) and water vapor partial pressure (P_{v,2}). Thus, P_{v,2} is known/set in the model. The required low vacuum vapor pressure (P_{v,7}) required to meet this dehumidification load is set based on a given pinch point vapor pressure difference (ΔP_{v,pinch}). Thus, P_{v,7} can be calculated according to Equation 11.

$${P}_{v , 7} = {P}_{v , 2} - Δ {P}_{v , pinch} \qquad ( 11 )$$

Estimating vacuum vapor pressure in this manner is analogous to estimating vapor compression cycle evaporator or condenser temperatures based on assumed pinch point temperature differences. Herein, we use a pinch vapor pressure difference of 0.5 kPa for the practical scenarios, falling in the expected range and 0 kPa for the ideal scenarios, representing a mass exchanger with 100% effectiveness. State 7 and State 8 are both assumed to be pure water vapor, which implies that the membranes are perfectly selective. This assumption has been applied in many modeling works for assessing theoretical thermodynamic energy requirements of the technology. The mass flowrate of water vapor removed in the dehumidification process is given by Equation 12.

$${\dot{m}}_{v} = {\dot{m}}_{a} ( {ω}_{1} - {ω}_{2} ) \qquad ( 12 )$$

Next, it is assumed that that when the water vapor is rejected to the exhaust air, the relative humidity is brought to 90% at State 5. With this assumption, a mass balance can determine the exhaust air flowrate (\dot{m}_{a,ex}) needed to achieve this condition.

$$R {H}_{5} = 90 \% \qquad ( 13 )$$

$${\dot{m}}_{v} = {\dot{m}}_{a , e x} ( {ω}_{5} - {ω}_{4} ) \qquad ( 14 )$$

Now, knowing the water vapor partial pressure at State 5, the rejection side water vapor partial pressure, P_{v,8}, can be calculated using the same pinch point vapor pressure difference as before.

$${P}_{v , 8} = {P}_{v , 5} + Δ {P}_{v , p i n c h} \qquad ( 15 )$$

The power consumption of the water vapor compressor is calculated by assuming an isentropic efficiency, as shown in Equation 16.

$${\dot{W}}_{W V C} = {\dot{m}}_{v} \frac{{h}_{v , 8 s} - {h}_{v , 7}}{{η}_{WVC}} \qquad ( 16 )$$

Here, h_{v,7} is the enthalpy of water vapor at a pressure of P_{v,7} and a temperature of T₁. h_{v,8s} is the enthalpy of the water vapor at a pressure of P_{v,8} under isentropic compression from State 7. η_{WVC} is the compressor isentropic efficiency, taken as 1 for the ideal scenarios and 0.7 for the practical scenarios.

The membrane dehumidification process is assumed to be isothermal (T₂=T₁). Therefore, the condenser energy balance is simply given by Equation 17.

$${\dot{Q}}_{c ond , M} = {\dot{m}}_{a} ( {h}_{3} - {h}_{2} ) \qquad ( 17 )$$

It should be noted that, in the baseline system, the evaporator was the minimum load that must be met in the system, and we know that as long as the evaporator load is met, there will be sufficient heat for reheating in the condenser. However, in the instant system, the reheating load in the condenser is the minimum load that must be met, and the evaporator load does not affect the drying process (other than the evaporator temperature affecting the heat pump COP). Thus, the energy input for reheating the process air is given by Equation 18 and is based on the condenser load.

$${\dot{W}}_{c ond , M} = \frac{{\dot{Q}}_{c ond , N}}{C O {P}_{H}} \qquad ( 18 )$$

Here, COP_{H} is the heating coefficient of performance and can either be the Carnot COP or practical COP (depending on the result being presented).

As was stated above, the ambient air evaporator makes use of the condensation to enable higher evaporating temperatures and therefore higher vapor compression cycle COPs. By assuming that RH₆=1 (since RH₅ is set at 0.90), T₆ is calculated iteratively by three coupled equations (Equations 3, 19, and 20). Essentially, the condenser load (\dot{Q}_{heat,M}) is set, the evaporator load depends on the heat pump COP, which depends on T₆ (which is dependent on the energy balance in Equation 20). Thus, three unknowns (\dot{Q}_{evap,M}, T₆, and COP_{c}) are solved iteratively.

$${\dot{Q}}_{evap , M} = {\dot{m}}_{aux} ( {h}_{5} - {h}_{6} ( {ω}_{5} - {ω}_{6} ) {h}_{w} ) \qquad ( 19 )$$

$${\dot{Q}}_{evap , M} = {\dot{Q}}_{cond , M} - {\dot{W}}_{cond , M} \qquad ( 20 )$$

Having determined T₆, the latent heat ratio on the evaporator can be expressed according to Equation 21.

$$L H R = \frac{{\dot{m}}_{a u x} ( {ω}_{5} - {ω}_{6} ) {h}_{fg}}{{\dot{Q}}_{evap , M}} \qquad ( 21 )$$

Additionally, the framework can be modified to assess the value of T₆ if no latent heat was available, which can then be used to estimate the heat pump COP when no latent heat is available, as will be shown below.

Several performance metrics are evaluated herein. The first is the energy savings. The energy savings metric simply compares baseline system power consumption to the instant power consumption. The baseline power consumption is simply equal to the vapor compression cycle power consumption. The instant system total power consumption is given by Equation 22.

$${\dot{W}}_{M} = {\dot{W}}_{W V C} + {\dot{W}}_{c ond , M} \qquad ( 22 )$$

In both systems, fan power consumption is not included in the current models. This would be specific to the system design, and is therefore outside the scope of this high-level analysis. Instead, we are more concerned in evaluating the fundamental thermodynamic requirements of heating and dehumidification in the two systems. Next, the drying efficiency relates the latent heat removal rate of the drying process divided by the total system power input, represented generally by Equation 23.

$${η}_{d} = \frac{{\dot{m}}_{a} ( {ω}_{3} - {ω}_{1} ) {h}_{f g}}{{\dot{W}}_{s y s}} \qquad ( 23 )$$

Herein, \dot{W}_{sys} generically represents the total system power consumption for either system (either \dot{W}_{b} or \dot{W}_{M}). The drying time (t_{dry}) represents the time to remove all of the water from a product. The mass of water in the product to be dried (m_{w,p}) can be set arbitrarily, and then for a given dry time and drying conditions, the air flowrate (\dot{m}ₐ) can be calculated iteratively by the model.

$${t}_{dry} = \frac{{m}_{w , p}}{{\dot{m}}_{a} ( {ω}_{3} - {ω}_{1} )} \qquad ( 24 )$$

In these analyses, ma is set at 0.0646 kg/s and m_{w,p} is set at 2.05 kg based on typical clothes drying applications. Of course, the eventual application for this technology is focused on industrial drying, though these clothes drying conditions provide a test case to study the thermodynamics.

The following results explore the thermodynamic performance of the instant concept and compare it to the baseline heat pump system. As has been alluded to above, two sets of results are presented in this section: one for the “ideal” scenario and one for a “practical” scenario. Table 1 summarizes the model inputs for these two scenarios.

TABLE 1
Summary of the model inputs for the ideal and practical scenarios

| Variable/Input | Ideal Scenario | Practical Scenario |
|---|---|---|
| Pinch vapor pressure | 0 [kPa] | 0.5 [kPa] |
| difference, ΔP_{v, pinch} | | |
| Compressor isentropic | 1 [—] | 0.70 [—] |
| efficiency, η_{wvc} | | |
| Heat pump second law | 1 [—] | 0.40 [—] |
| efficiency, η_{II} | | |

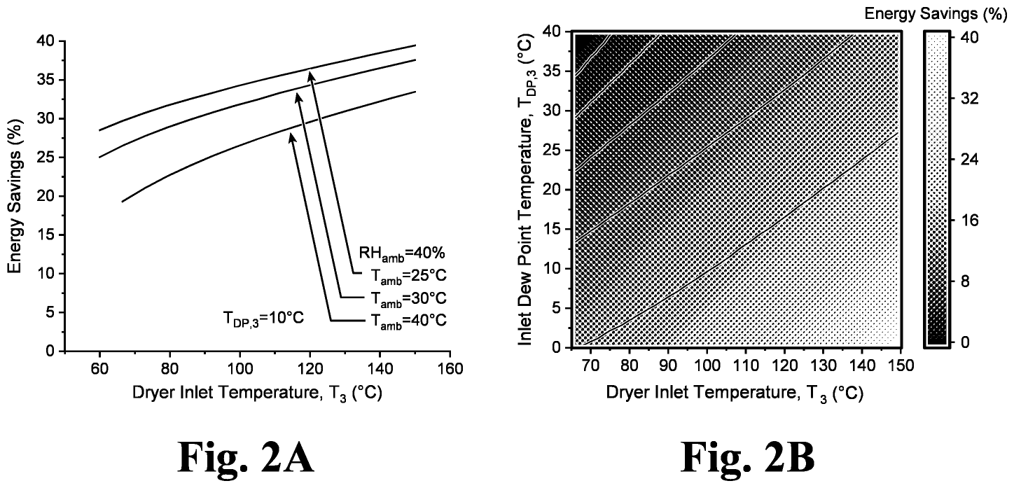

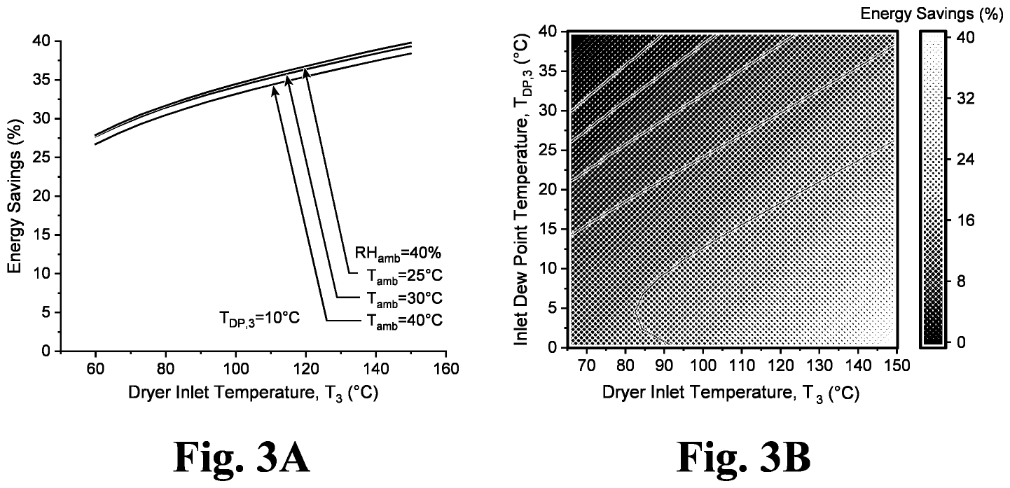

First, the energy savings of the instant system compared to the baseline heat pump drying system are evaluated. FIG. 3A-3B displays the energy savings for the ideal scenario, and FIG. 2A-2B displays the energy savings for the practical scenario.

A few interesting trends can be noticed from these plots. First is that energy savings are generally higher for drying applications with high drying temperatures. As drying temperature increases, the dehumidification load increases exponentially, and reheating energy requirements increase linearly. Since membrane dehumidification specifically targets improving the energy input associated with the humidity loads, it is expected that greater energy savings would be achieved when these humidity loads become more significant.

Additionally, for a given drying temperature, an optimal dryer inlet dew point temperature (for the practical scenario) will exist, shown by FIG. 2B. At sufficiently low inlet dew point temperatures, very low vacuum pressures are required to achieve this inlet dew point, and therefore the instant system achieves lower energy savings. Furthermore, at high inlet dew point temperatures, vapor compression cycles will have a high COP, and therefore the energy savings of membrane dehumidification become less pronounced.

Lastly, the instant is less suitable for low-temperature applications with high dryer inlet dew point temperatures (shown by the negative energy savings in the top left of FIG. 2B and FIG. 3B). In these scenarios, humidity loads would be relatively small and heat pump COPs would be very high, negating the need for energy efficient membrane dehumidification. However, these conditions are not conducive for convective drying and are therefore not likely used in many applications.

Next, the enhancement from air-side condensation in the instant evaporator is quantified. To clarify this concept, a certain amount of heat must be absorbed by the evaporator to sufficiently reheat the air in the condenser. Without condensation from State 5 to State 6, the evaporator would need to impose a large temperature change to the exhaust air stream. This in turn would mean that lower evaporator temperatures would be required, lowering the heat pump COP. But, with a substantial amount of the evaporator heat being pulled from the condensation process, less temperature change (sensible cooling) is provided to the exhaust air. Therefore, higher evaporator temperatures and higher COPs can be achieved when latent heat is available. The COP assuming no latent heat is available is denoted as COP_{dry}, whereas the COP with available latent heat is denoted COP_{wet} in this section.

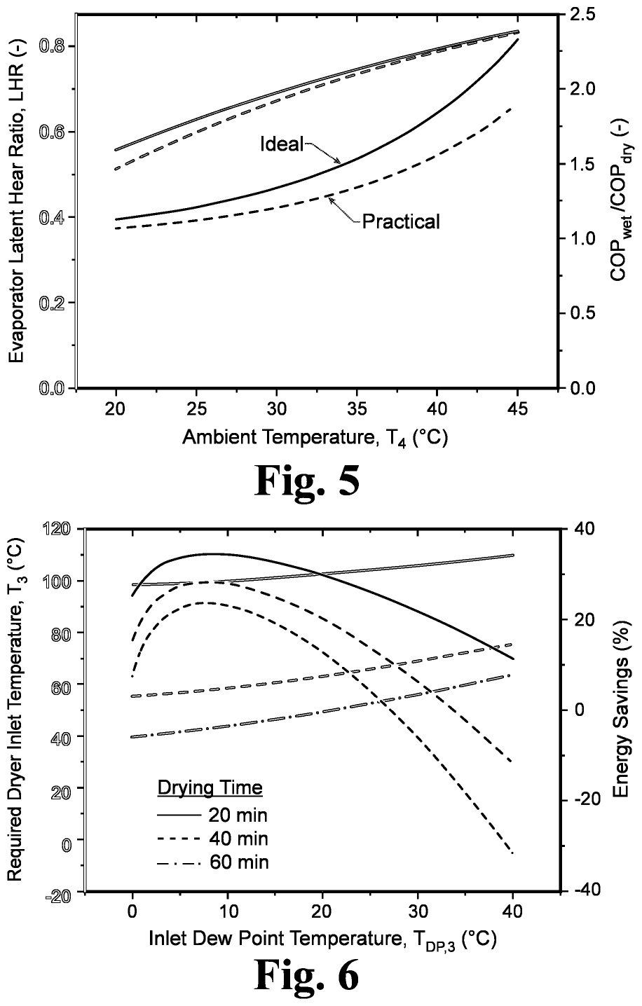

For the conditions analyzed in FIG. 5, we showed that the latent heat fraction ranged between 0.5 to 0.8. As the LHR increased and the evaporator temperature increased, the heat pump COP could be nearly doubled. Compounding this improved heat pump COP with the lower heating loads and efficient membrane dehumidification, the instant concept has great potential to provide significant savings.

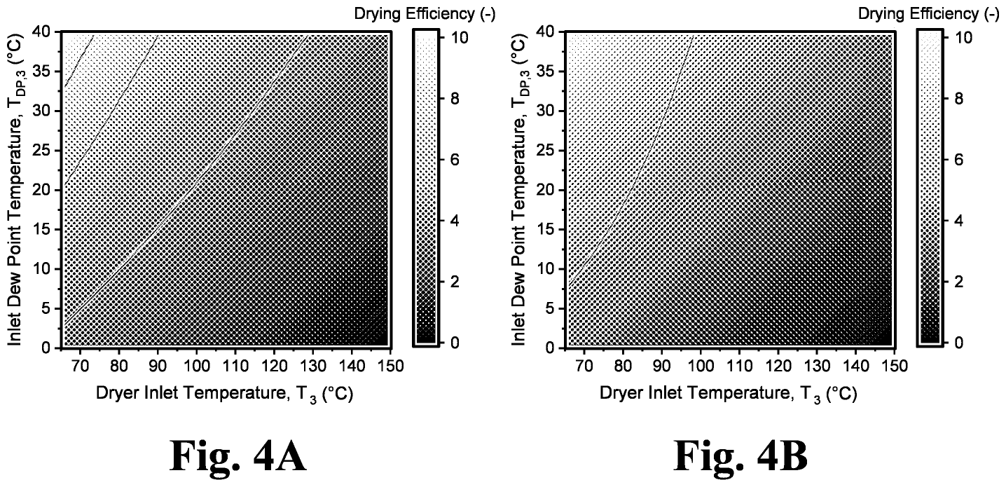

Next, the drying efficiency is evaluated as defined by Equation 23 in FIG. 4A-4B. The drying efficiency is evaluated as function of the drying temperature and inlet dew point temperature for a set ambient condition. As can be seen in FIG. 4A-4B, the ideal drying efficiency ranges between 3-10 whereas in the practical scenario, the drying efficiency ranges between 0.8-3. A drying efficiency greater than 1 implies that the specific energy input for drying was less than the enthalpy of vaporization for water. A drying efficiency of 1 should be considered the minimum acceptable efficiency. The range of drying efficiencies below 1 in FIG. 4A occur where the heat pump supply temperature is very high (high heat pump energy input and low heat pump COP) and the inlet dew point temperature is low (requiring significant energy consumption from the water vapor compressor). This represents a rather extreme application/condition, though it is important to recall that, even though the drying efficiency dips below 1, the energy savings would still be positive relative the baseline system. Some combination of heat pump heating and resistive heating could potentially bring this drying efficiency closer to 1.

Lastly, we evaluate the impact that the dryer inlet dew point temperature has on the required inlet dryer temperature. The inlet dryer temperature (T₃) is plotted as a function of the dryer inlet dew point temperature for a constant drying time in FIG. 6. Essentially, as the inlet to the dryer becomes more humid (higher dew point temperature), a higher drying temperature (T₃) is required to compensate and maintain a constant drying temperature.

As can be seen, reducing the dryer inlet dew point temperature could lead to drying temperature reductions on the order of 10-20° C. This is important for the technology because, achieving exceptionally high temperatures for drying with heat pumps can be challenging. However, if the goal is to electrify many drying processes, reducing inlet humidity conditions with membrane dehumidification can enable lower dryer temperatures (attainable with heat pumps) without sacrificing drying time. Plus, compared to the baseline heat pump system providing the same supply and dew point conditions, the instant system may provide energy savings on the order of 20-25% for lower inlet dew point temperature conditions.

Having observed the energy saving potential of the instant system, the geometric design of membrane modules has become a focal point of interest. Membrane Energy Exchangers (MEEs) designed for air dehumidification can be classified into two types based on their shape: flat sheet and hollow fiber. Flat sheet membranes (FSM) resemble plate heat exchangers, utilizing spacers between channels to support the membrane structure. On the other hand, hollow fiber membranes (HFM) are akin to shell-and-tube heat exchangers and possess self-supporting capabilities. When comparing the two, HFMs are the preferred choice due to their higher surface-to-volume ratio, enhancing compactness for a given surface area.

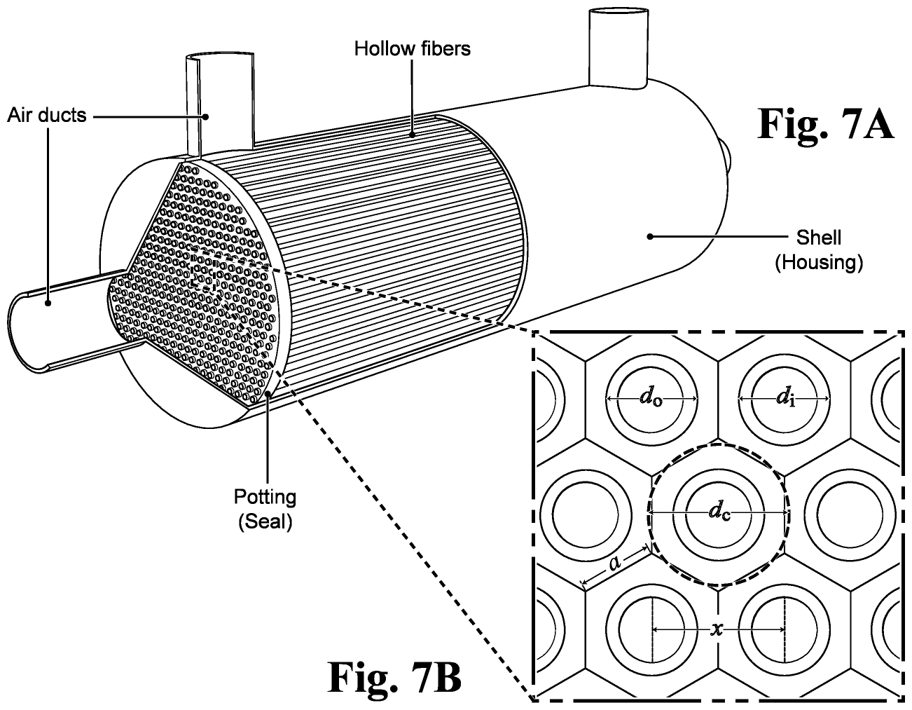

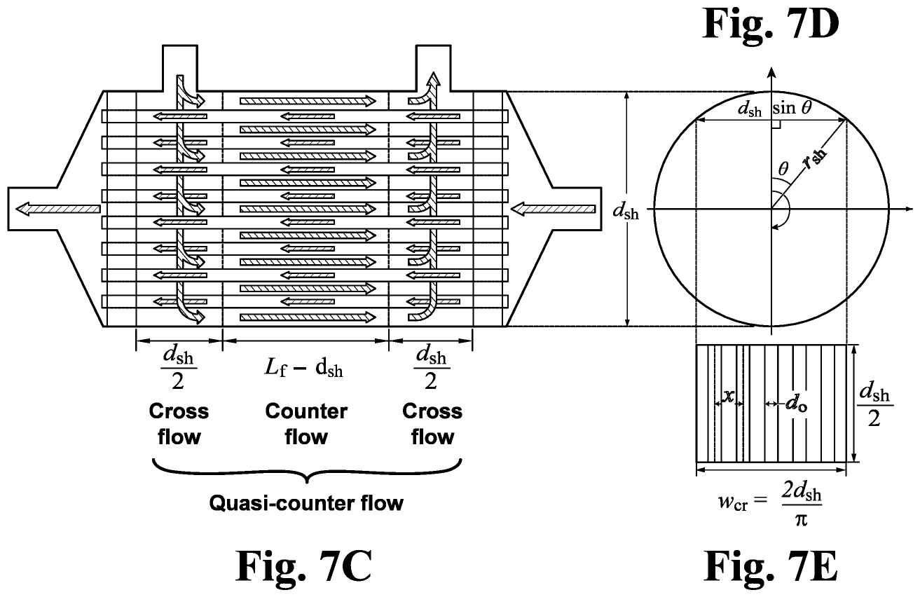

Hollow fiber membrane manufacturing is a multifaceted process involving various stages, all of which leverage cutting-edge equipment to ensure precision and quality. In the initial phase, polymer solutions are meticulously prepared using advanced dissolving tanks and precision mixing equipment to guarantee uniformity. The spinning process, a critical step, employs state-of-the-art hollow fiber spinning machines equipped with sophisticated extruders and spinnerets, ensuring precise fiber formation. Fiber morphology is further controlled through air gap control systems and quench baths, contributing to the overall uniformity of the product. Post-treatment involves washing and drying units, designed for optimal removal of residual solvents and fine-tuning of membrane properties. This integrated and technology-driven approach ensures the production of high-quality hollow fiber membranes. Lastly, a module shell is prepared to contain the hollow fiber bundles and the shell-side (fiber outer) and lumen-side (fiber inner) are separated by using a resin-based sealing as shown in FIG. 7A-7E.

A 3D and projected views of a typical HFM module are depicted in FIG. 7A-7E. Encased within a housing, the hollow fibers are segregated from the ambient shell-side air by seals positioned at both ends. The fiber configuration (lumen-side) is presumed to be hexagonally arranged, as depicted in the magnified front view. Equation 25 defines the packing fraction, denoted as ϕ, representing the cross-sectional area ratio of fibers to the module.

$$ϕ = {n}_{f} \frac{{d}_{o}^{2}}{{d}_{sh}^{2}} \qquad ( 25 )$$

Here, n_{f}, dₒ, and dₛₕ are number of fibers, fiber outer diameter, and shell diameter, respectively. The cross-sectional flow area of shell- (Aₛₕ) and lumen- (Aₗᵤ) side air can be expressed as Equations 26 and 27 respectively, where dᵢ is the fiber inner diameter.

$${A}_{s h} = ( 1 - ϕ ) \frac{π {d}_{sh}^{2}}{4} \qquad ( 26 )$$

$${A}_{l u} = {n}_{f} \frac{π {d}_{i}^{2}}{4} \qquad ( 27 )$$

The compactness, denoted as r_{A,v}, represents the surface-to-volume ratio, as indicated in Equation 28, where L_{f} corresponds to the fiber length.

$${r}_{A , V} = \frac{{A}_{o}}{V} = \frac{{n}_{f} π {d}_{o} {L}_{f}}{\frac{π}{4} {d}_{sh}^{2} {L}_{f}} = \frac{4 {n}_{f} {d}_{o}}{{d}_{sh}^{2}} \qquad ( 28 )$$

The imaginary cell diameter for a single fiber is computed using Equation 29 based on Happel's free surface model. The free surface diameter (d_{c}) can be obtained by rearranging

$$\frac{π {d}_{sh}^{2}}{4} = {n}_{f} \frac{π {d}_{c}^{2}}{4} .$$

$${d}_{c} = {d}_{o} {ϕ}^{- \frac{1}{2}} = {d}_{s h} {n}_{f}^{- \frac{1}{2}} \qquad ( 29 )$$

Subsequently, the hydraulic diameters for the shell-side (d_{h,sh}) and lumen-side (d_{h,lu}) are determined from the definition

$${d}_{h} = \frac{4 A}{P} ,$$

resulting in Equations 30 and 31.

$${d}_{h , s h} = {d}_{c} - {d}_{o} \qquad ( 30 )$$

$${d}_{h , lu} = {d}_{i} \qquad ( 31 )$$

By establishing the cell areas of the hexagon and circle based on the free surface diameter, the side length of the hexagon (a) can be determined, as expressed in Equation 32.

$$a = {[ \frac{π}{6 \sqrt{3}} ]}^{\frac{1}{2}} {d}_{c} \qquad ( 32 )$$

Consequently, the distance between the centers of each fiber (x) is derived according to Equation 33.

$$x = \sqrt{3} a \qquad ( 33 )$$

The air flow configuration of the HFM is modeled as quasi-counter flow, a combination of cross and counter flow, as illustrated in the side view in FIG. 7A-7E. Assuming lumen-side air flows from right to left, the shell-side air must cross the fibers at the inlet and outlet, with the remaining portion in pure counter flow. Past studies have addressed this issue by relying on Computational Fluid Dynamics (CFD) analysis to solve for the overall effectiveness. Herein, we propose a simple method to estimate quasi-counter flow effectiveness. Initially, we assume a cross-flow length

$$( \frac{{d}_{sh}}{2} )$$

at each end is half the shell diameter. A pure cross-flow configuration arises when the length-to-diameter ratio (r_{L,d}) equals one. Conversely, a quasi-counter flow configuration is established when r_{L,d} exceeds one, as defined in Equation 34.

$${r}_{L , d} = \frac{{L}_{f}}{{d}_{sh}} \{ \begin{matrix}{r}_{L , d} = 1 : Pure - cross flow \\ {r}_{L , d} > 1 : Quasi - Counter flow\end{matrix} \qquad ( 34 )$$

As the length-to-diameter ratio increases, the portion of pure counter flow also increases, resulting in a length-weighted overall effectiveness (εₒᵥᵣ) for heat and mass transfer, as shown in Equation 35. Here, ε_{cr} and ε_{co} indicate the effectiveness for cross and counter flow, respectively.

$${ε}_{o v r} = \frac{{d}_{s h}}{{L}_{f}} {ε}_{c r} + \frac{{L}_{f} - {d}_{s h}}{{L}_{f}} {ε}_{c o} \qquad ( 35 )$$

The average width through which air flows within the cylinder shell (w_{cr}) is depicted in the cross-sectional view in FIG. 7A-7E. The average cross-flow area (A_{cr}) can be estimated by subtracting the flow area blocked by the fibers, as shown in the top view in FIG. 7A-7E. Thus, the average width, average cross-flow area, and hydraulic diameter for cross flow are expressed in Equations 36-38, respectively.

$${w}_{c r} = \frac{{\int }_{0}^{π} {d}_{s h} sin θ d θ}{π} = \frac{2}{π} {d}_{s h} \qquad ( 36 )$$

$${A}_{c r} = [ 1 - \frac{{d}_{o}}{x} ] \frac{{d}_{sh}^{2}}{π} \qquad ( 37 )$$

$${d}_{h , cr} = ( x - {d}_{o} ) [ \frac{{d}_{s h}}{x - {d}_{o} + 0.5 {d}_{s h}} ] \qquad ( 38 )$$

Considering the well-known fact that the effectiveness of cross flow is usually 10-20% lower than that of counter flow, Equation 35 will consistently yield a value between the two, aligning with previous results in the literature. While more complex analyses, such as CFD or discretization, may offer better estimates, the current methodology is deemed a reasonable and cost-effective approach to model quasi-counter flow problems.

Until recently, humidity ratio has served as the primary driving force in the modeling of water vapor transport for membrane dehumidification. However, considering the analogy between heat conduction and moisture diffusion, it becomes evident that vapor partial pressure should be the true driving force. A recent study by the authors introduced a general ε-NTU method applicable to various membrane dehumidification devices, focusing on partial pressure differences. This method utilizes an NTU based on moisture transport, proving particularly valuable in analyzing vacuum membrane dehumidification (VMD) systems that operate under sub-ambient pressure and water vapor dominant conditions. The same ε-NTU formulation is employed for sensible heat transfer, utilizing temperature difference as the driving potential.

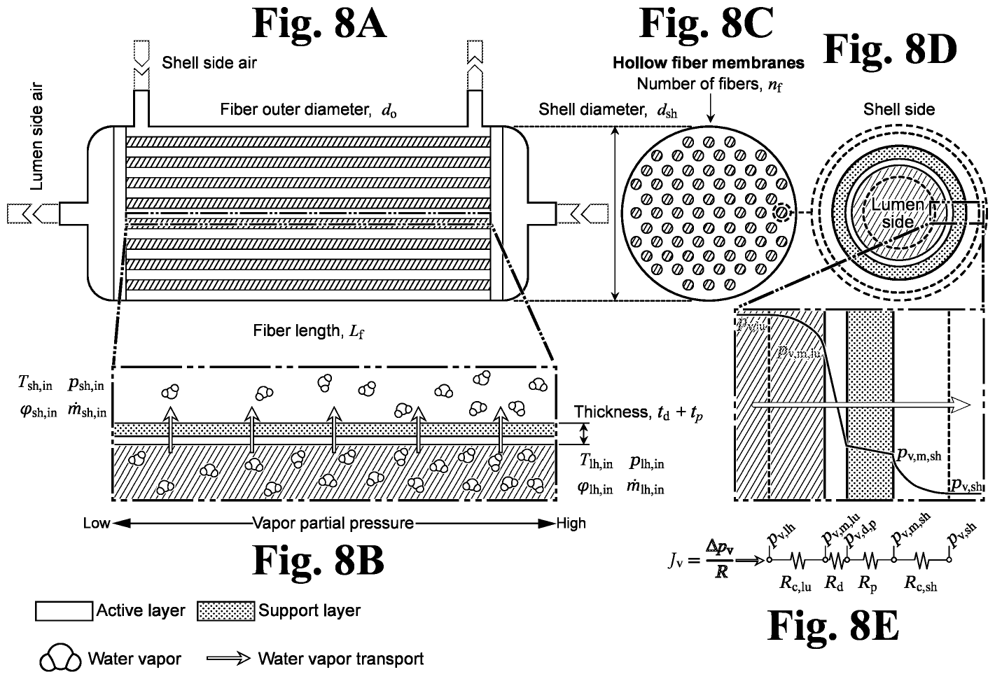

A schematic diagram illustrating HFM geometries and the mass transfer resistance network is presented in FIG. 8A-8E. It can be seen that water vapor is transferred from high to low vapor partial pressure, as depicted in the magnified view of the HFM. Concentration polarization occurs at the solid-gas interface due to convective mass transfer resistance, with the vapor partial pressure difference being higher in the active layer than in the support layer.

As permeability is an established property of the membrane, our objective is to determine the convective mass transfer coefficient, denoted as k, to comprehensively characterize the mass transport phenomena. The Reynolds number, Re, is defined as the ratio of dynamic to viscous force, expressed as the ratio of mass flux

$$( G = \frac{\dot{m}}{{A}_{c}} )$$

and viscosity (μ) in Equation 39.

$$R e = \frac{G {d}_{h}}{μ} \qquad ( 39 )$$

Subsequently, the Prandtl number (Pr) and Schmidt number (Sc) are expressed as the ratios of kinematic viscosity (v) to thermal diffusivity (α_{T}), and vapor-air diffusivity (Dᵥₐ), respectively, as defined in Equations 40 and 41.

$$P r = \frac{v}{{α}_{T}} \qquad ( 40 )$$

$$Sc = \frac{v}{{D}_{va}} \qquad ( 41 )$$

According to the Chilton-Colburn analogy, the Nusselt number (Nu) can be expressed as a function of the Sherwood number (Sh) and the Lewis

$$( Le = \frac{P r}{s c} ) ,$$

as given in Equation 42.

$$N u = Sh \cdot {Le}^{\frac{1}{3}} \qquad ( 42 )$$

The Sherwood number on the lumen side, denoted as Shₗᵤ, is determined using the established correlation by Leveque, as presented in Equation 43. In this equation, Gz represents the Graetz number, defined as

$$G z = \frac{{d}_{I 1}}{L} R e$$

$$S {h}_{l u} = 1.62 \cdot {Gz}^{\frac{1}{3}} \qquad ( 43 )$$

Determining the shell-side Sherwood number, Shₛₕ, is more intricate compared to the lumen side due to the involvement of the random distribution of fibers and mixed flow within the shell. For this analysis, the correlation put forth by Costello et al. (1993) was chosen owing to its high prediction accuracy and is shown in Equation 44.

$$S {h}_{s h} = ( 0.53 - 0.58 ϕ ) R {e}^{0.53} S {c}^{0.33} \qquad ( 44 )$$

Subsequently, the convective heat transfer coefficient (h) and mass transfer coefficient (k) can be obtained from the Nu and Sh numbers using Equations 45 and 46.

$${h}_{c} = N u \frac{λ}{{d}_{h}} \qquad ( 45 )$$

$$k = Sh \frac{D}{{d}_{h}} \qquad ( 46 )$$

The overall heat transfer coefficient (Uₕ), measured in

$$\frac{1}{{m}^{2} s K} ,$$

is defined by Equation 47, considering cylindrical coordinates within a heat transfer resistance network.

$${U}_{h} = {[ \frac{1}{{h}_{c , lu}} \frac{{d}_{o}}{{d}_{t}} + ln ( \frac{{d}_{o}}{{d}_{i}} ) \frac{{d}_{o}}{2 {λ}_{m}} + \frac{1}{{h}_{c , sh}} ]}^{- 1} \qquad ( 47 )$$

An equivalent expression is established for the overall mass transfer coefficient (Uₘ), measured in

$$\frac{kg}{{m}^{2} s Pa} ,$$

derived from the mass transfer resistance network illustrated in FIG. 8A-8E. This expression is defined by Equation 48. Since the mass transfer coefficients determined using Equation 46 are based on humidity ratio differences, it becomes necessary to convert them for use with partial pressure differences. To make this conversion from humidity ratio-driven to partial pressure-driven units, we make the assumption of ideal gas air-water vapor mixtures, leading to the formulation in Equation 48. In this equation, Mᵥ is the water vapor molecular weight, Rᵥ is the gas constant of water vapor

$$( \frac{R}{{M}_{v}} ) ,$$

and dₘ is the middle diameter of fibers at the porous and dense layer interface.

$${U}_{m} = {[ \frac{{R}_{v} {T}_{l u}}{{k}_{l u}} \frac{{d}_{o}}{{d}_{i}} + ln ( \frac{{d}_{m}}{{d}_{i}} ) \frac{{d}_{o}}{2 {P}_{d} {M}_{v}} + ln ( \frac{{d}_{o}}{{d}_{m}} ) \frac{{d}_{o}}{2 {P}_{p} {M}_{v}} + \frac{{R}_{v} {T}_{s h}}{{k}_{s h}} ]}^{- 1} \qquad ( 48 )$$

To determine the mass transfer capacity of the air flows, an analogy was developed for the specific humidity capacity (c_{p,h}), outlined in Equation 49.

$${c}_{p , h} = \frac{d ω}{d {p}_{v}} \approx \frac{d}{d {p}_{v}} ( \frac{0.622 {p}_{v}}{{p}_{a}} ) = \frac{0.622}{{p}_{a}} \qquad ( 49 )$$

Recall that the specific heat capacity (cₚ) represents the necessary thermal energy to alter the temperature of 1 kg mass by

$$1 K ( \frac{J}{kg K} ) .$$

Similarly, C_{p,h} can be conceptually understood as the required water vapor mass to alter the vapor partial pressure of 1 kg air by

$$1 Pa ( \frac{{kg}_{v}}{{kg}_{a} Pa} ) .$$

Now, the neat and mass transfer capacities of air flows are expressed in Equations 50 and 51, respectively.

$${C}_{h} = \dot{m} {c}_{p} \qquad ( 50 )$$

$${C}_{m} = \dot{m} {c}_{p , h} \qquad ( 51 )$$

From this point, we can insert Equations 47-51 into Equations 52-55 to compute capacity ratios CRₕ and CRₘ and the number of transfer units (NTU) for both heat and mass transfer.

$$C {R}_{h} = \frac{{c}_{h , min}}{{c}_{h , max}} \qquad ( 52 )$$

$$C {R}_{m} = \frac{{c}_{m , min}}{{c}_{m , max}} \qquad ( 53 )$$

$$N T {U}_{h} = \frac{{U}_{h} {A}_{o}}{{c}_{h , min}} \qquad ( 54 )$$

$$N T {U}_{m} = \frac{{U}_{m} {A}_{o}}{{c}_{m , min}} \qquad ( 55 )$$

The effectiveness values for sensible (heat) and latent (mass) transfer in counterflow, denoted as ε_{co}, are calculated using Equation 56.

$${ε}_{co} = \{ \begin{matrix}\frac{1 - exp [ - N T U ( 1 - C R ) ]}{1 - C R \cdot exp [ - N T U ( 1 - C R ) ]} ( C R < 1 ) \\ \frac{N T U}{1 + N T U} ( CR = 1 )\end{matrix} \qquad ( 56 )$$

The effectiveness for crossflow, ε_{cr}, when one flow is mixed (shell-side), is determined using Equation 57.

$${ε}_{c r} = \{ \begin{matrix}1 - exp [ - C {R}^{- 1} [ 1 - exp ( - N T U \cdot C R ) ] ] & ( {C}_{s h} = {C}_{min} ) \\ C {R}^{- 1} [ 1 - exp [ - C R ( 1 - exp ( - N T U ) ) ] ] & ( {C}_{s h} = {C}_{max} )\end{matrix} \qquad ( 57 )$$

Subsequently, the overall effectiveness (εₒᵥᵣ) is determined using Equation 35, as discussed earlier. The overall heat and mass transfer rates for the HFMs are then calculated using Equations 58 and 59.

$${\dot{Q}}_{s} = {ε}_{ovr , h} [ {C}_{h , min} Δ {T}_{i n} ] \qquad ( 58 )$$

$${\dot{m}}_{v} = {ε}_{ovr , m} [ {C}_{m , min} Δ {p}_{v , in} ] \qquad ( 59 )$$

The pressure drop for each air-water vapor flow stream, denoted as Δp, is obtained by solving the Darcy-Weisbach equation using the laminar flow friction factor

$$( f = \frac{64}{R e} ) ,$$

as presented in Equation 60. Here, K is the flow loss coefficient at the entrance and exit.

$$Δ p = \frac{1}{2} \frac{{G}^{2}}{ρ} [ f \frac{L}{{d}_{h}} + \sum K ] \qquad ( 60 )$$

The power consumption of the fan, \dot{W}_{f}, is the sum of lumen- and shell-side fan power, expressed in Equation 61, where η_{f} and ηₘ represent the fan and motor efficiency, respectively. The fan and motor efficiency are assumed to be 75% and 90%, respectively, based on ASHRAE standards.

$${\dot{W}}_{f} = {[ \frac{\dot{V} Δ p}{{η}_{f} {η}_{m}} ]}_{l u} + {[ \frac{\dot{V} Δ p}{{η}_{f} {η}_{m}} ]}_{s h} \qquad ( 61 )$$

Finally, from Equations 59 and 61, the equivalent COP, or latent COP, is formulated as Equation 62, incorporating the enthalpy of vaporization of water (h_{f}_{_{g}}=2387 kJ·kg⁻¹).

$${COP}_{e q} = \frac{{\dot{m}}_{v} {h}_{f g}}{{\dot{W}}_{f}} \qquad ( 62 )$$

Herein, it is worth noting that the latent COP for dehumidifying air through condensation using heat pumps typically falls around 3. This value serves as a reference point when assessing the performance of membrane dehumidification.

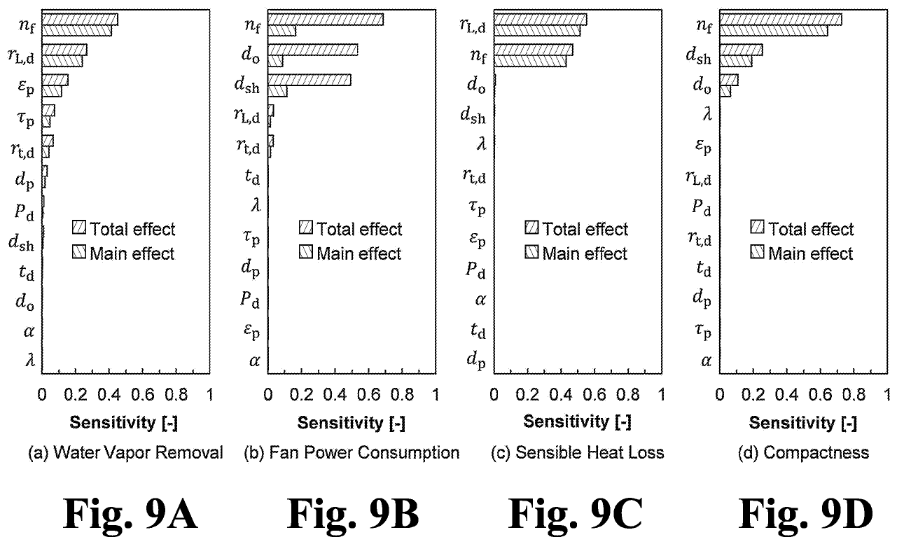

Combining the HFM geometries with the partial pressure-driven ε-NTU method outlined above, simulation results are obtained to analyse the impact of input variables on passive membrane dehumidification performance. The sensitivity analysis in FIG. 9A-9D provides insights into the impact of 12 input variables on four key objective functions. Notably, module geometries (indicated in blue text) and membrane properties (highlighted in red) are assessed and ranked for their influence. The nominal and min/max values of the simulation conditions are summarized in Table 2.

For water vapor removal (FIG. 9A) the number of fibers and length-to-diameter ratio play pivotal roles, significantly affecting membrane surface area. Interestingly, the microstructure of support layers and pore size have a more pronounced effect than the dense layer's H₂O permeability, suggesting that the fiber walls' microporous structure strongly influences dehumidification performance.

Examining fan power consumption (FIG. 9B), geometric characteristics take the forefront—specifically, the number of fibers, outer diameter, and shell diameter. These variables significantly impact hydraulic diameter and mass flux, whereas membrane properties show no discernible influence.

Sensible heat loss mirrors the trends observed for water vapor removal (FIG. 9C), with the number of fibers and length-to-diameter ratio playing crucial roles. Surprisingly, thermal conductivity has minimal impact, attributed to the large surface area and extremely thin fiber walls that mitigate thermal resistance.

Compactness, as defined by the number of fibers, shell diameter, and fiber outer diameter, aligns with its numerical definition (FIG. 9D). This reinforces the importance of these geometric parameters in determining the surface-to-volume ratio.

Overall, the analysis underscores that HFM-based ERVs are more sensitive to module geometries than membrane properties. Consequently, the subsequent optimization efforts will primarily focus on adjusting module geometries while keeping membrane properties at their nominal conditions.

TABLE 2
Nominal and min/max values of simulation parameters

| Type | Parameter | Symbol | Unit | Nominal | Min. | Max. |
|---|---|---|---|---|---|---|
| Module | Shell diameter | dₛₕ | mm | 100 | 75 | 125 |
| geometries | Fiber outer diameter | dₒ | mm | 1.5 | 1.0 | 2.0 |
| | Dense layer thickness | t_{d} | μm | 5 | 1 | 9 |
| | Number of fibers | n_{f} | — | 1800 | 200 | 3400 |
| | Length-to-diameter ratio | r_{L, d} | — | 8 | 2 | 14 |
| | Thickness-to-diameter ratio | r_{t, d} | — | 0.2 | 0.1 | 0.3 |
| Membrane | Thermal conductivity | λ | W · m⁻¹K⁻¹ | 0.2 | 0.02 | 2 |
| properties | Dense layer H₂O permeability | P_{d} | Barrer | 10⁵ | 10³ | 10⁷ |
| | H₂O/N₂ selectivity | α | — | 10⁵ | 10³ | 10⁷ |
| | Pore size | dₚ | μm | 0.2 | 0.02 | 2 |
| | Porosity | εₚ | — | 0.5 | 0.1 | 0.9 |
| | Tortuosity | τₚ | — | 3 | 1 | 5 |
| Operating | Dryer inlet temperature | T_{dry, in} | ° C. | 70 | 40 | 100 |
| conditions | Dryer inlet relative humidity | φ_{dry, in} | % | 5 | 1 | 40 |
| | Dryer inlet mass flow rate | \dot{m}_{dry, in} | kg · h⁻¹ | 22 | 10 | 34 |
| | Drying effectiveness | ε_{dry} | — | 0.5 | 0.1 | 0.9 |
| | Ambient temperature | T_{amb} | ° C. | 25 | −10 | 40 |
| | Ambient relative humidity | φ_{amb} | % | 50 | 5 | 100 |
| | Ambient mass flow rate | \dot{m}_{amb} | kg · h⁻¹ | 22 | 10 | 34 |

Based on the sensitivity analysis, only the HFM geometries were chosen as input variables for the multi-objective optimization study. The explicit objectives are to maximize water vapor removal and compactness while minimizing fan power consumption and sensible heat loss. Utilizing the TOPSIS method for multi-criteria decision making, the top five most promising candidates were identified from the Pareto solutions, as shown in Table 3. The optimized design and form factors for HFM-ERVs are determined by averaging the values for each design variable, resulting in an enhanced design that excels across all objective functions.

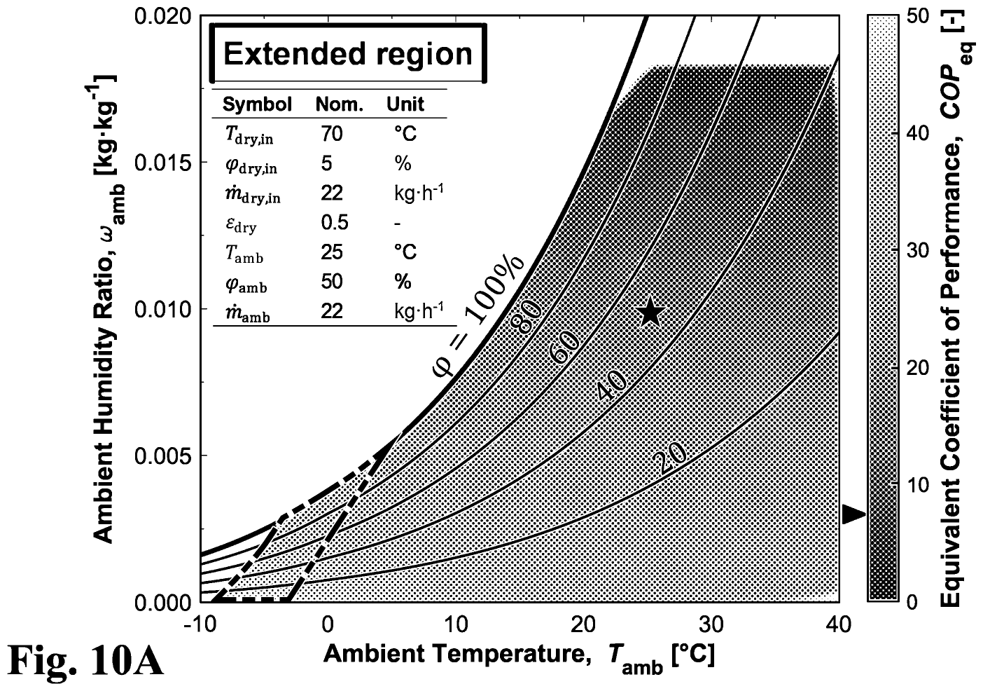

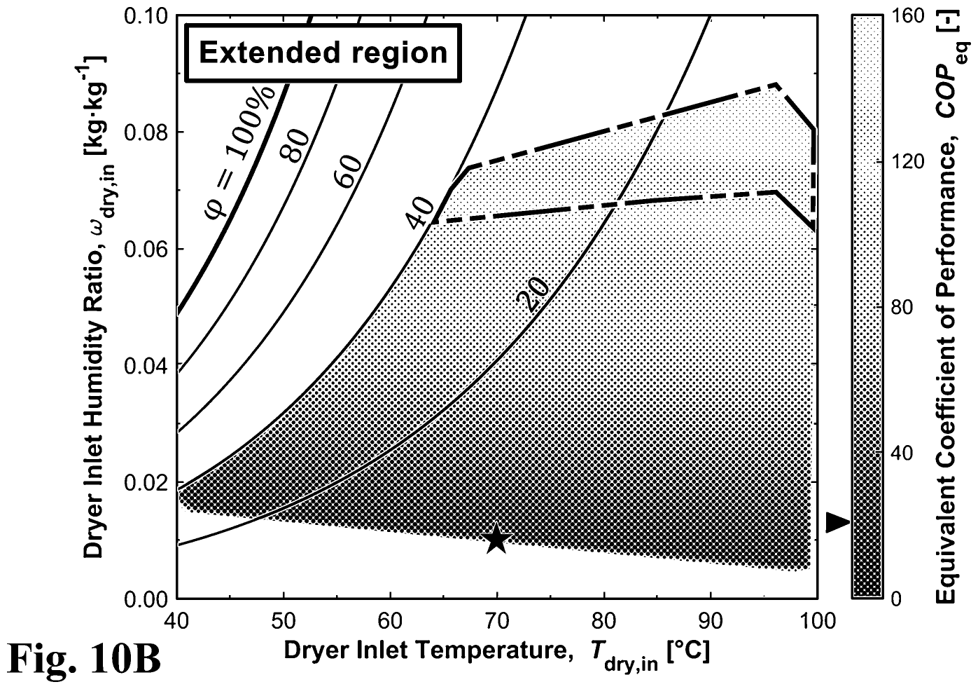

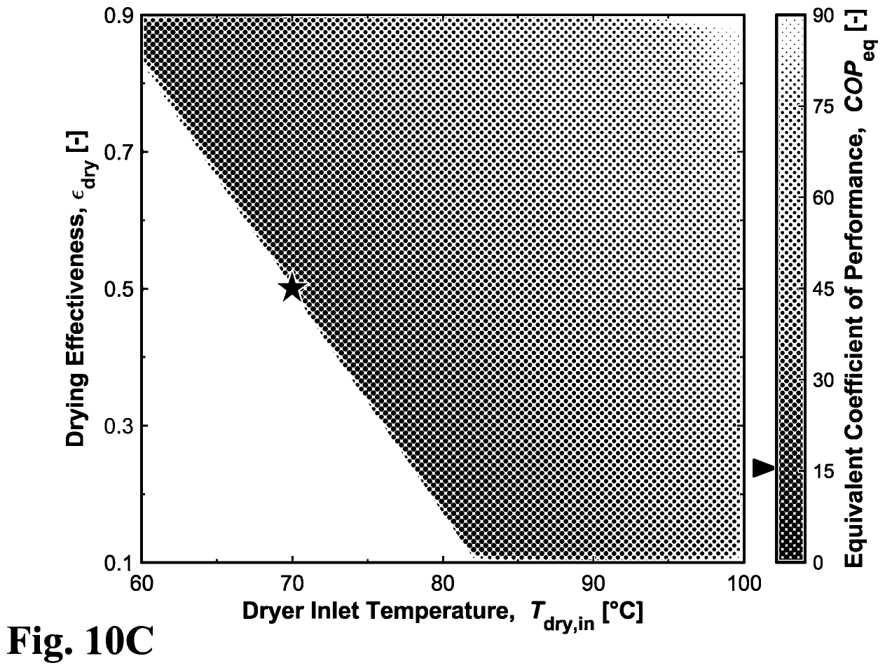

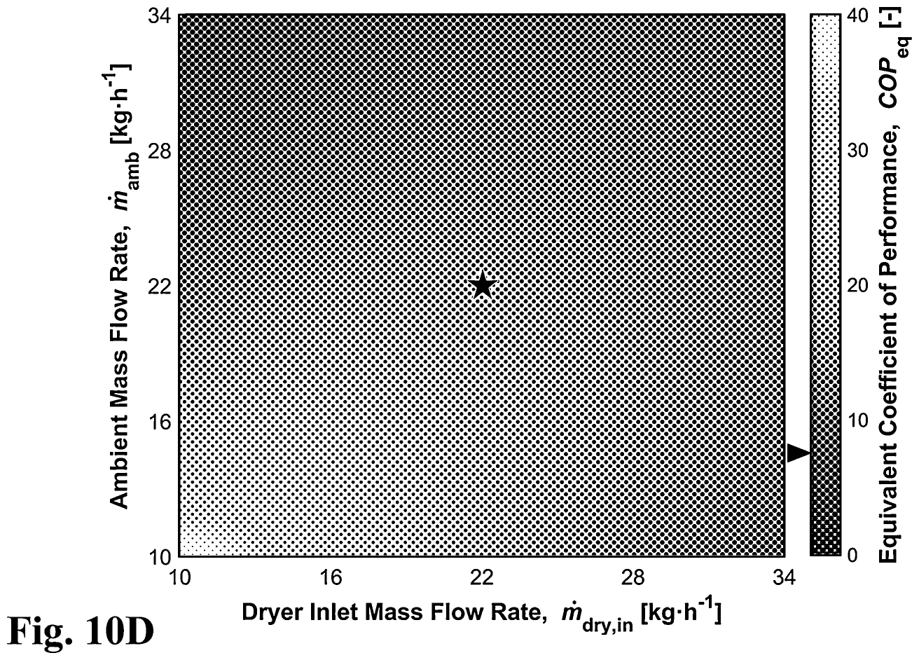

FIG. 10A-10D illustrates the impact of operating conditions on the equivalent COP for the optimized design, considering the ranges in Table 2. Since the operating conditions remained consistent during the design optimization process, it is crucial to evaluate whether the optimized design surpasses the baseline under diverse conditions. Notably, the pink triangles denote the maximum COP values of the baseline design. The consistent observation is that the optimized design consistently outperforms the baseline in all scenarios. Notably, the optimized design demonstrates an average COP improvement of 460% over the baseline design across a broad spectrum of conditions.

In FIG. 10A, COP increases with decreasing ambient temperature and humidity ratio. Lower temperatures result in higher air density, reducing volume flow rate and pressure drop, leading to lower fan power consumption. Lower humidity ratios increase the vapor partial pressure difference, enhancing water vapor removal.

FIG. 10B shows a slight COP increase with rising dryer inlet temperature, constrained by increased air volume flow rate. Higher humidity ratios at the dryer inlet led to a higher COP due to an augmented vapor partial pressure difference. The red boxes in FIG. 10A-B highlight the expanded operating conditions range for the optimized design, attributed to reduced sensible heat loss compared to the baseline.

FIG. 10C depicts COP rising with increased dryer inlet temperature and drying effectiveness, leading to higher humidity ratios at the dryer outlet. In FIG. 10D, the highest COP values are associated with the lowest air mass flow rates for both lumen- and shell-sides. Herein, the optimized design consistently outperforms the baseline in all scenarios, emphasizing its superiority.

TABLE 3
Design and performance comparison of Pareto solutions and baseline

| | Design variables | | | | | | Objective functions | | | | Variations | | | |
|---|---|---|---|---|---|---|---|---|---|---|---|---|---|---|
| | dₛₕ | dₒ | t_{d} | n_{f} | r_{L, d} | r_{t, d} | \dot{m}ᵥ | \dot{W}_{f} | \dot{Q}ₛ | r_{A, V} | \dot{m}ᵥ | \dot{W}_{f} | \dot{Q}ₛ | r_{A, V} |
| Case | mm | mm | μm | — | — | — | mg · s⁻¹ | W | W | cm² · cm⁻³ | % | % | % | % |
| Baseline | 100.0 | 1.50 | 5.00 | 1800 | 8.00 | 0.200 | 38.10 | 30.4 | 130.8 | 10.80 | — | — | — | — |
| Alt. 1 | 116.0 | 1.53 | 1.44 | 2996 | 2.86 | 0.102 | 38.11 | 6.41 | 119.0 | 13.66 | +0.02 | −78.9 | −9.03 | +26.5 |
| Alt. 2 | 118.7 | 1.52 | 1.51 | 3102 | 3.04 | 0.103 | 38.73 | 6.30 | 120.4 | 13.44 | +1.65 | −79.3 | −7.95 | +24.4 |
| Alt. 3 | 121.5 | 1.59 | 1.38 | 2981 | 2.81 | 0.102 | 38.14 | 5.23 | 118.7 | 12.88 | +0.11 | −82.8 | −9.21 | +19.2 |
| Alt. 4 | 113.4 | 1.47 | 1.41 | 3082 | 3.01 | 0.111 | 38.32 | 7.41 | 120.0 | 14.07 | +0.58 | −75.6 | −8.25 | +30.3 |
| Alt. 5 | 121.9 | 1.59 | 1.38 | 2981 | 2.85 | 0.102 | 38.26 | 5.13 | 119.1 | 12.75 | +0.42 | −83.1 | −8.98 | +18.1 |
| Optimized | 118.0 | 1.50 | 1.40 | 3029 | 2.90 | 0.100 | 38.30 | 5.43 | 119.4 | 13.05 | +0.52 | −82.1 | −8.72 | +20.8. |

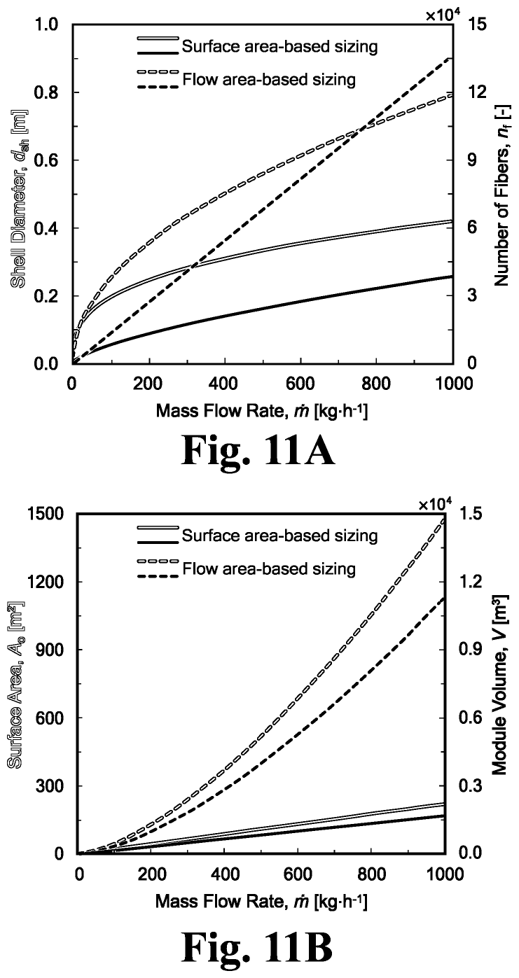

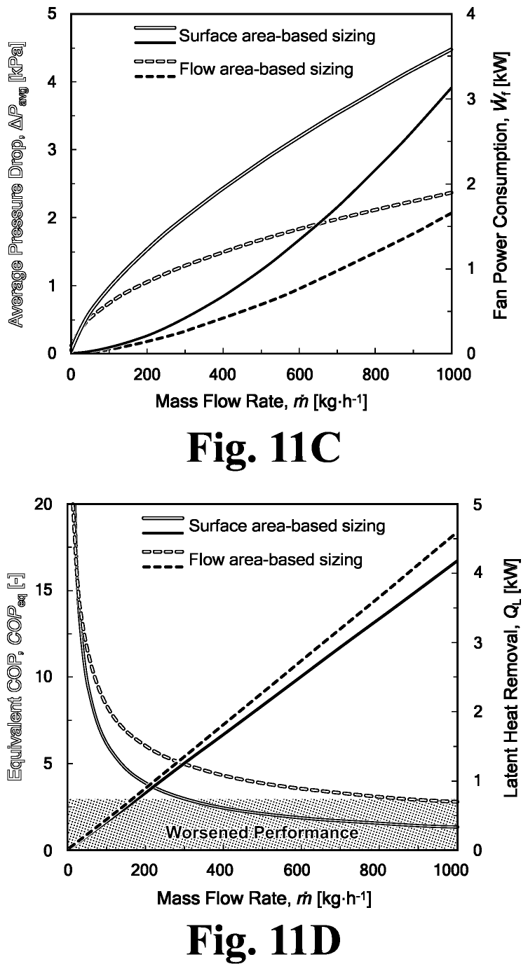

Accurate module sizing is essential, especially when applied across varying mass flow rates and scales. Herein, module sizing is achieved by scaling a nominal design while preserving the optimized form factor, with the fiber outer diameter fixed at 1.5 mm. This constraint is practical because the polymer fibers must maintain self-supporting capabilities even with their thin walls (wall thickness ˜150 microns). FIG. 11A-D presents a comparison of two distinct module sizing approaches based on the nominal mass flow rate. The surface area-based sizing method estimates the required surface area using Equation 63, while the flow area-based sizing approach calculates the cross-sectional area of the air flows to maintain a fixed mass flux, as described in Equation 64.

$${A}_{o} = \frac{\dot{m}}{{\dot{m}}_{n o m}} {A}_{o , nom} \qquad ( 63 )$$

$${A}_{c} = \frac{\dot{m}}{{\dot{m}}_{n o m}} {A}_{c , nom} \qquad ( 64 )$$

In the given equations, \dot{m}ₙₒₘ and \dot{m} represent the nominal and scaled air mass flow rates, respectively. A_{o,nom} and A_{c,nom} indicate the nominal surface area and cross-sectional flow area. Both methods vary only the shell diameter (dₛₕ) and number of fibers (n_{f}), while other variables (dₒ, t_{d}, r_{L,d}, r_{t,d}) are fixed to maintain the optimized form factor. Membrane properties and operating conditions, excluding air mass flow rates, are kept at nominal values. The surface area-based method aims for material efficiency, estimating the minimum membrane area for desired water vapor removal. Conversely, the flow area-based method prioritizes efficiency, aiming to minimize air pressure drop while maintaining fixed mass flux.

FIG. 11A-11B show that the module's predicted overall size and dimensions, based on the flow area-based sizing approach, are notably larger than those estimated by the surface area-based sizing method. However, the flow area-based sizing approach results in lower pressure drop and fan power consumption for the same mass flow rate, as depicted in FIG. 11C. The pressure drop increases with the mass flow requirement due to the growing module length with an increasing shell diameter for a fixed length-to-diameter ratio. Consequently, in FIG. 11D, the equivalent COP for both sizing methods experiences an exponential decrease as the mass flow rate increases.

The shaded area in FIG. 11D represents a less efficient performance range compared to a baseline COP of 3, typical for an air conditioning unit. This underscores the advantage of employing multiple smaller HFM-ERV units in parallel rather than a single large unit. For instance, when dealing with a mass flow rate of 400 kg·h⁻¹, it is more advantageous to use four parallel 100 kg·h⁻¹ units than a single 400 kg·h⁻¹ unit. This recommendation is driven by limitations imposed by fiber dimensions and the associated increase in pressure drop due to extended module length. While presenting a limitation under high mass flow rates, careful design considerations can still yield a more efficient dehumidification system compared to conventional condensation methods.

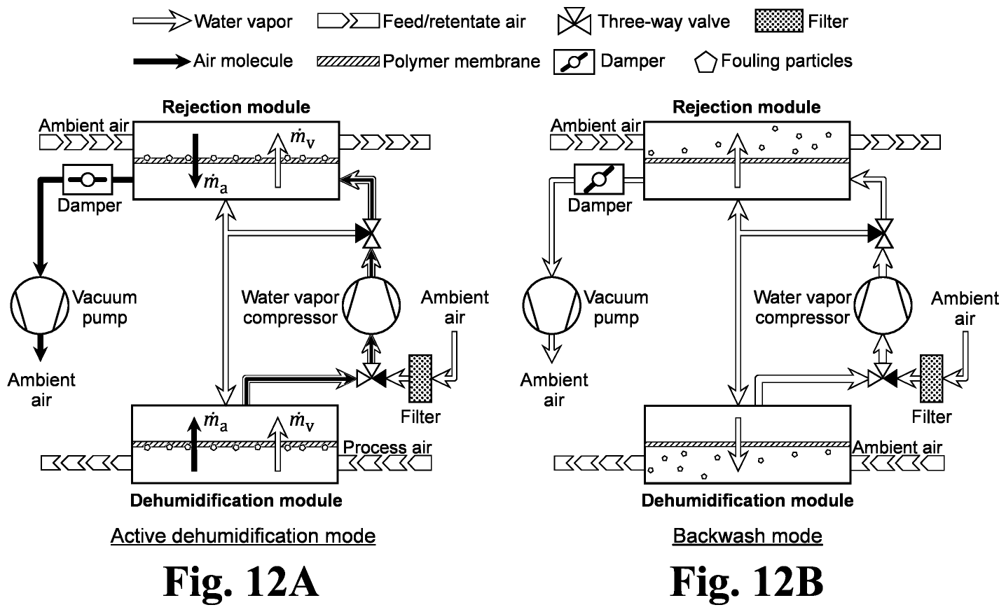

Recalling the active membrane dehumidification in the instant system from FIG. 1B, FIG. 12A provides a detailed illustration of the dual-module humidity pump (DMHP). The process air flowing into the dehumidification module originates from the dryer outlet. In this setup, the water vapor compressor creates a vacuum pressure of approximately 1 kPa, extracting water vapor. Theoretically, transporting only water vapor is preferable, but air is also introduced into the system due to the finite membrane H₂O/N₂ selectivity.

After pressurization by the compressor to about 10 kPa, the water vapor and air flow into the rejection module. In this module, the gas sweeps over the membrane surface, creating a counterflow configuration with the other side exposed to ambient air. Here, water vapor permeates through the membrane due to a higher vapor partial pressure, but additional air enters the system because of the lower air partial pressure inside the rejection module. To prevent air pressure build-up and the formation of air diffusion barrier, a vacuum pump is necessary to expel the remaining air and maintain the operating pressure for water vapor removal.

A critical requirement for proper operation is the synchronization of the vacuum pump and water vapor compressor rotational speeds. Both need to be variable-speed devices with intelligent control strategies, since the key is to control the lower and higher pressures of the system without the use of an expansion valve. Theoretically, it has been demonstrated that the DMHP can achieve a COP as high as 10, even under practical conditions, if the vacuum pump exclusively rejects pure air without any water vapor. This challenge can be mitigated by introducing an asymmetric size for the dehumidification and rejection modules, with the rejection module sufficiently large to successfully expel all dehumidified water vapor to the other side of the membrane.

In addition to the operation mode of the DMHP, FIG. 12B illustrates a novel strategy to mitigate membrane fouling. Drawing inspiration from the backwash mode commonly employed for desalination and water purification membranes, the current design allows for membrane cleaning by reversing the air flow from the inside to the outside. This can be easily achieved by incorporating two three-way valves, enabling the water vapor compressor to compress ambient air (1 atm) to around 1.1-1.2 atm, creating a reversed driving force to remove any dust or particles that may have adhered to the membrane surface. As the backwash mode aims to prevent membrane fouling and enhance membrane resilience, the damper is closed, and the vacuum pump is turned off to pressurize the inner module adequately.

In conclusion, the novel system concept of the instant system combines selective membrane dehumidification with a heat pump for industrial drying applications. The theoretical models were used to explore energy savings and efficiency trends, relative to a baseline heat pump drying system modeled under an identical set of assumptions for fair comparison. It was found that, for the conditions analyzed, up to 40% energy savings could be possible, and negative energy savings are also possible under some extreme conditions. The vapor compression cycle COP can be improved by almost 2× due to the available latent heat in the evaporator for the instant system, marking a unique advantage to the clever thermal system design. The drying efficiency was found to range between 3-10 under ideal conditions and 0.8-3 under more practical conditions. Furthermore, drying temperatures could be reduced by 10-20° C. while maintaining equivalent drying times and saving up to 25% of the energy input for drying. Additionally, a simplified, length-weighted overall effectiveness for heat and mass transfer under quasi-counter flow configurations was initially demonstrated, yielding reasonable estimations. The HFM model was developed by integrating geometries into a partial pressure-driven ε-NTU method. The sensitivity analysis revealed that membrane properties had less effect than module geometries in terms of dehumidification performance. The optimum module length-to-diameter ratio and packing fraction were found to be 2.9 and 0.49, respectively. The optimized performance showed a latent COP of 40-160, which significantly exceeds the COP of using a conventional heat pump drying system, with an average improvement of 460%. The scalability results indicated that employing multiple smaller units in parallel is more efficient than using a single large unit due to restrictions in self-supporting fiber diameter. Lastly, a new design was proposed for the DMHP with special consideration for the synchronized control of the vacuum pump and compressor rotational speeds for efficient operation. A strategy to prevent membrane fouling and ensure an extended lifetime was suggested by using three-way valve controls. Overall, the instant system shows great potential to offer significant energy savings and process control for industrial drying applications.

Nomenclature

| Variables and Acronyms | | Subscripts | |
|---|---|---|---|
| Variable/Acronym | Symbol/ | Subscript | |
| Name | Abbreviation | Meaning | Symbol |
| Coefficient of | COP | Air flow | a |
| Performance | | | |
| Compressor | η_{wvc} | Auxiliary | aux |
| Isentropic | | Condenser | |
| Efficiency | | | |
| Convective heat | h_{c} | Ambient Exhaust | ex |
| transfer coefficient | | Airflow | |
| Convective mass | k | Baseline system | b |
| transfer coefficient | | | |
| Compactness | r_{A, V} | Condenser | cond |
| Drying Time | t_{dry} | Carnot Heat | Carnot |
| | | Pump | |
| Drying Efficiency | η_{d} | Cooling | C |
| Effectiveness; | ε | Evaporator | evap |
| porosity | | | |
| Engineering Equation | EES | Heat of | fg |
| Solver | | Vaporization | |
| Enthalpy | h | Heating | H |
| Fiber outer diameter | dₒ | Liquid Water | w |
| | | Property | |
| Happel's free surface | d_{c} | Instant System | M |
| diameter | | | |
| Humidity Ratio | ω | Pinch Point | pinch |
| | | Difference | |
| Heat Transfer Rate | \dot{Q} | Reheating | heat |
| | | Requirement | |
| Latent Heat Ratio | LHR | Total System | sys |
| | | Energy | |
| Length-to-diameter | r_{L, d} | Water Vapor | v |
| ratio | | Property | |
| Mass Flowrate | \dot{m} | Water Vapor | WVC |
| Mass of Water in | m_{w, p} | Compressor | |
| Product | | | |
| Number of fibers | n_{f} | | |
| Packing fraction | ϕ | | |
| Power Consumption | \dot{W} | | |
| Permeability | P | | |
| Pressure | p | | |
| Pressure Difference | Δp | | |
| Pore size | dₚ | | |
| Relative Humidity | RH | | |
| Second Law | η_{II} | | |
| Efficiency | | | |
| Selevtivity | α | | |
| Shell diameter | dₛₕ | | |
| Temperature | T | | |
| Thickness-to- | r_{t, d} | | |
| diameter ratio | | | |
| Thermal conductivity | λ | | |
| Tortuosity | τ | | |

In some embodiments, the instant system may run in an active mode, as described above, or a passive mode that rejects vapor without an energy input. Some embodiments include a combination of novel air-blocking, water vapor passing membranes, cooling coils within the membrane module, and a unique heat pump design for a transformative reduction in energy needs. This reduces energy demands of heat pump systems by up to 80%, by a combination of avoiding condensing water, a dual membrane design that requires only pumping small amounts of vapor, a reduced temperature differential for the heat pump from separating latent and sensible heat transfer, and a passive mode that rejects vapor without an energy input. Novel membranes, made of polyether block amide resin thermoplastic elastomer-graphene oxide composites, can pass 10,000 molecules of vapor for every molecule of air, allowing for drying without the large energy costs associated with condensation.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments may also be implemented in combination in a single embodiment. Conversely, various features that are described in the context of a single embodiment may also be implemented in multiple embodiments separately or in any suitable sub-combination. Moreover, although features may be described above as acting in certain combinations and even initially claimed as such, one or more features from a claimed combination may in some cases be excised from the combination, and the claimed combination may be directed to nigh-infinite sub-combinations or variations of a sub-combination.

What is claimed is:

1. A dryer, comprising:
a drying volume;
a first membrane module operationally connected to the drying volume, wherein the first membrane module further comprises at least one first water selective membrane operationally connected within a housing for unidirectionally transporting water across said first water selective membrane;
a condenser operationally connected to the drying volume and to the first membrane module;
a second membrane module operationally connected to the first membrane module and to an ambient air input source wherein the second membrane module further comprises at least one second water selective membrane operationally connected within a housing for unidirectionally transporting water across said second water selective membrane; and
an evaporator operationally connected to the second membrane module and to the condenser.

2. The dryer of claim 1 and further comprising:
a load to be dried positioned in the dryer volume; and
a pump operationally connected to the dryer volume;
wherein heated moist air travels from the dryer volume to the first membrane module;
wherein moist air travels from the first membrane module to the second membrane module;
wherein dried air travels from the first membrane module to the condenser;
wherein ambient air flows into the second membrane module;
wherein moist air travels from the second membrane module to the evaporator;
wherein chilled condensate travels from the evaporator;
wherein heated dry air travels from the evaporator to the condenser; and
wherein moistened air travels from the condenser to the evaporator.

3. The dryer of claim 2 and further comprising:
a check valve operationally connected between the evaporator and the condenser;
wherein moistened air from the condenser travels through the check valve to the evaporator.

4. The dryer of claim 1 wherein each respective membrane module defines an enclosure bisected by water permeable membrane for extracting water from moist air circulated therethrough; and wherein each membrane is a polyether block amide resin thermoplastic elastomer-graphene oxide composite.

5. The dryer of claim 1 wherein the dryer may be operated in a mode selected from the group consisting of an active mode and a passive mode.

6. The dryer of claim 1 wherein each respective membrane module further comprises:
a housing defining an interior volume having first and second inlet ports and
first and second outlet ports operationally connected thereto;
a plurality of hollow elongated fibers positioned in the interior volume and operationally connected within the housing;
wherein each respective hollow elongated fiber further comprises an elongated hollow support portion and an elongated hollow water selective membrane portion operationally connected to a respective elongated hollow support portion;
wherein each respective fiber is connected in fluidic communication with the first inlet port and the first outlet port;
wherein the second inlet port and the second outlet port are connected in fluidic communication with the interior volume.

7. A method of drying, comprising:
a) loading a mass to be dried into a drying volume;
b) circulating air from the drying volume into a first membrane module;
c) circulating moist air from the first membrane module to a second membrane module and circulating dried air from the first membrane module to a condenser;
d) circulating moist air from the second membrane module to an evaporator;
e) draining condensate from the evaporator;
f) circulating moist air from the condenser to the evaporator;
g) circulating heated dry air form the evaporator to the condenser; and
h) circulating heated dry air from the condenser to the drying volume.

8. The method of claim 7 wherein each respective membrane module defines an enclosure bisected by a water permeable membrane for extracting water from moist air circulated therethrough.

9. The method of claim 7 wherein each respective membrane module further comprises:
a housing defining an interior volume having first and second inlet ports and
first and second outlet ports operationally connected thereto;
a plurality of hollow elongated fibers positioned in the interior volume and operationally connected within the housing;
wherein each respective hollow elongated fiber further comprises an elongated hollow support portion and an elongated hollow water selective membrane portion operationally connected to a respective elongated hollow support portion;
wherein each respective fiber is connected in fluidic communication with the first inlet port and the first outlet port;
wherein the second inlet port and the second outlet port are connected in fluidic communication with the interior volume.

10. The method of claim 9 wherein the driving force for drying air moving through a membrane module is generated by a water vaper partial pressure differential.

11. A dryer assembly, comprising:
a drying volume;
a first membrane module operationally connected to the drying volume;
a condenser operationally connected to the drying volume and to the first membrane module;
a second membrane module operationally connected to the first membrane module and to an ambient air input source;
an evaporator operationally connected to the second membrane module and to the condenser;
a load to be dried positioned in the dryer volume;
a pump operationally connected to the dryer volume; and
a check valve operationally connected between the evaporator and the condenser;
wherein heated moist air travels from the dryer volume to the first membrane module;
wherein moist air travels from the first membrane module to the second membrane module;
wherein dried air travels from the first membrane module to the condenser;
wherein ambient air flows into the second membrane module;
wherein moist air travels from the second membrane module to the evaporator;
wherein chilled condensate travels from the evaporator;
wherein heated dry air travels from the evaporator to the condenser;
wherein moistened air travels from the condenser to the evaporator;
wherein moistened air from the condenser travels through the check valve to the evaporator;
wherein each respective membrane module defines a generally cylindrical elongated enclosure and a plurality of elongated hollow members operationally connected therein for extracting water from moist air circulated therethrough;
wherein each respective elongated hollow member further comprises an elongated tubular water selective membrane portion defining a first diameter and a first length; and
wherein each water selective membrane portion is a polyether block amide resin thermoplastic elastomer-graphene oxide composite.

12. The dryer assembly of claim 11 wherein each respective elongated hollow member further comprises a respective elongated tubular support portion operationally connected to each respective elongated tubular water selective membrane portion.

13. The dryer assembly of claim 11 wherein the ratio of the first length to the first diameter is 2.9 and wherein the plurality of elongated hollow members fill 49 percent of the generally cylindrical elongated enclosure.

14. The dryer assembly of claim 13 wherein the first diameter is about 2 mm.

15. The dryer assembly of claim 14 wherein a first inlet port is operationally connected to the plurality of elongated hollow members; wherein a first outlet port is operationally connected to the plurality of elongated hollow members and disposed opposite the first inlet port; wherein a second inlet port is operationally connected to the generally cylindrical elongated enclosure; wherein a second outlet port is operationally connected to the generally cylindrical elongated enclosure; and wherein air flow may be established in a first direction through the plurality of elongated members and in a second, opposite direction through the generally cylindrical elongated enclosure.

16. The dryer assembly of claim 15 wherein the ratio of the first length to the first diameter is 2.9; wherein the plurality of elongated hollow members fill 46 percent of the generally cylindrical elongated enclosure; wherein, the ratio of the fiber thickness to first diameter is 0.1; and wherein, each respective fiber has an outer diameter of 1.5 mm.

17. The dryer assembly of claim 11 and further comprising a plurality of membrane modules operationally connected in parallel.

18. A dual-module drying system comprising:
a variable-speed vacuum pump;
a variable-speed water vapor compressor;
a membrane module for water vapor rejection and operationally connected to the variable-speed vacuum pump and to the variable-speed water vapor compressor;
a membrane module for water vapor dehumidification operationally connected to the membrane module for water vapor rejection;
an air filter for pre-treatment;
a three-way valve for flow control operationally connected to the membrane module for water vapor dehumidification and to the air filter for pre-treatment; and
a damper for vacuum line separation operationally connected to the variable-speed vacuum pump and to the membrane module for water vapor rejection.

19. The dual-module drying system of claim 18 wherein process air flowing into the membrane module for water vapor dehumidification originates from a dryer outlet; wherein, the variable-speed water vapor compressor generates a vacuum force to extract water vapor from the air; wherein air is introduced into the system due to finite membrane H₂O/N₂ selectivity; wherein water vapor and air flow into the membrane module for water vapor rejection after being compressed by the variable-speed water vapor compressor; wherein water vapor and air sweep over the membrane surface to create a counterflow configuration; wherein water vapor is rejected through the membrane as additional air enters the system due to lower air partial pressure inside the membrane module for water vapor rejection; wherein the variable-speed vacuum pump expels remaining air; wherein the variable-speed vacuum pump and the variable-speed water vapor compressor rotational speeds are synchronized; wherein two three-way valves are operationally connected to the system to change operation modes to backwash mode for cleaning the membrane; wherein a reversed flow of air is introduced from the ambient to the variable-speed water vapor compressor to remove any particles adhered to the membrane surface; and wherein the damper is closed and the variable-speed vacuum pump is turned off for the water vapor compressor to pressurize a respective module.
